(19) United States
(12) Patent Application Publication
(10) Pub. No.: US 2026/0205595 A1
(43) Pub. Date: Jul. 16, 2026

(54) ENHANCED RESIDUAL DATA CODING

(71) Applicant: InterDigital CE Patent Holdings, SAS, Paris (FR)

(72) Inventors: Edouard FRANCOIS, Bourg des Comptes (FR); Karam NASER, mouazé (FR); Ya CHEN, Rennes (FR); Gwenaelle MARQUANT, la chapelle chaussee (FR); Fabrice URBAN, Thorigne Fouillard (FR)

(21) Appl. No.: 19/136,982

(22) PCT Filed: Dec. 8, 2023
(86) PCT No.: PCT/EP2023/084880

§ 371 Date: Jun. 9, 2025

(30) Foreign Application Priority Data
Dec. 19, 2022 (EP) 22306940.2
Feb. 9, 2023 (EP) 23305175.4

(51) Int. Cl. H04N 19/132; H04N 19/157; H04N 19/176; H04N 19/61; H04N 19/63; H04N 19/70

(52) U.S. Cl. CPC H04N 19/132; H04N 19/157; H04N 19/176; H04N 19/61; H04N 19/70; H04N 19/63

(57) ABSTRACT

Apparatuses and methods are presented for encoding and decoding video data. Techniques disclosed provide for the coding of a video block into a bitstream, including down-sampling a transform block and transforming the down-sampled transform block to generate a coefficient block to be coded into the bitstream. Techniques disclosed also provide for decoding a video block from the bitstream, including inverse transforming a coefficient block to reconstruct a down-sampled transform block, and up-sampling the down-sampled transform block, reconstructing therefrom a transform block.

### CROSS REFERENCE TO RELATED APPLICATIONS

This application claims the benefit of European Application No. 22306940.2, filed on Dec. 19, 2022, and of European Application No. 23305175.4, filed on Feb. 9, 2023, which are incorporated herein by reference in their entirety.

### BACKGROUND

Predictive coding techniques utilize temporal and spatial redundancy in a video sequence to efficiently compress the video content. In these techniques, a video frame is partitioned into video blocks that are each coded by a prediction block and a residual block. The former predicts the video block, and the latter represents the difference between the prediction block and the video block. The coding of the residual block is typically performed by a transform-based coding, applied to the whole or to a partition of the residual block, namely, a transform block. To reduce the complexity of transform-based coding, as done under the VVC standard, only a subblock of the transform block is transformed and coded into the bitstream. Such an approach may be effective when the energy of residual samples of the transform block is concentrated within the coded subblock. However, if this is not the case, coding only that subblock may introduce a perceptible distortion in the reconstructed video block.

### SUMMARY

Aspects disclosed in the present disclosure describe methods for encoding video data. The methods include coding a video block of the video data into a bitstream. The coding comprises down-sampling a transform block and transforming the down-sampled transform block, generating therefrom a coefficient block to be coded into the bitstream. Where, the transform block contains residual samples, each representing a difference between corresponding samples of the video block and a prediction block, predicting the video block. Aspects also describe methods for decoding video data. The methods include decoding a video block of the video data from a bitstream. The decoding comprises inverse transforming a coefficient block, reconstructing a down-sampled transform block, and up-sampling the down-sampled transform block to reconstruct a transform block.

Aspects disclosed in the present disclosure describe apparatuses for encoding video data. The apparatuses comprise at least one processor and memory storing instructions. The instructions, when executed by the at least one processor, cause the apparatuses to code a video block of the video data into a bitstream. The coding comprises down-sampling a transform block and transforming the down-sampled transform block, generating therefrom a coefficient block to be coded into the bitstream. Where, the transform block contains residual samples, each representing a difference between corresponding samples of the video block and a prediction block, predicting the video block. Aspects also describe apparatuses for decoding video data. The apparatuses comprise at least one processor and memory storing instructions. The instructions, when executed by the at least one processor, cause the apparatuses to decode a video block of the video data from a bitstream. The decoding comprises inverse transforming a coefficient block, reconstructing a down-sampled transform block, and up-sampling the down-sampled transform block to reconstruct a transform block.

Further aspects disclosed in the present disclosure describe a non-transitory computer-readable medium comprising instructions executable by at least one processor to perform methods for encoding video data. The methods include coding a video block of the video data into a bitstream. The coding comprises down-sampling a transform block and transforming the down-sampled transform block, generating therefrom a coefficient block to be coded into the bitstream. Where, the transform block contains residual samples, each representing a difference between corresponding samples of the video block and a prediction block, predicting the video block. Further aspects describe a non-transitory computer-readable medium comprising instructions executable by at least one processor to perform methods for decoding video data. The methods include decoding a video block of the video data from a bitstream. The decoding comprises inverse transforming a coefficient block, reconstructing a down-sampled transform block, and up-sampling the down-sampled transform block to reconstruct a transform block.

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

### BRIEF DESCRIPTION OF THE DRAWINGS

FIG. 1 is a block diagram of an example system, according to which aspects of the present embodiments can be implemented.

FIG. 2 is a functional block diagram of an example video encoder, according to which aspects of the present embodiments can be implemented.

FIG. 3 is a functional block diagram of an example video decoder, according to which aspects of the present embodiments can be implemented.

FIG. 4 illustrates transform block coding in a subblock transform (SBT) mode, according to which aspects of the present embodiments can be implemented.

FIG. 5 is a functional block diagram of an example enhanced-transformer and an example inverse enhanced-transformer, according to which aspects of the present embodiments can be implemented.

FIG. 6 illustrates transform block coding in an enhanced subblock transform (ESBT) mode, according to which aspects of the present embodiments can be implemented.

FIG. 7 is a functional block diagram of an example video encoder with dual layer coding, according to which aspects of the present embodiments can be implemented.

FIG. 8 is a functional block diagram of an example video decoder with dual layer decoding, according to which aspects of the present embodiments can be implemented.

FIG. 9 illustrates transform block coding, utilizing a wavelet transform, according to which aspects of the present embodiments can be implemented.

FIG. 10 illustrates selection of transform kernels, according to which aspects of the present embodiments can be implemented.

FIG. 11 is a flowchart of an example method for encoding video data, according to which aspects of the present embodiments can be implemented.

FIG. 12 is a flowchart of an example method for decoding video data, according to which aspects of the present embodiments can be implemented.

FIG. 13 is a functional block diagram illustrating an enhanced video encoder, according to which aspects of the present embodiments can be implemented.

FIG. 14 is a functional block diagram illustrating an enhanced video decoder, according to which aspects of the present embodiments can be implemented.

FIG. 15 illustrates video block coding in a combined subblock transform (SBT) mode and an enhanced subblock transform (ESBT) mode, according to which aspects of the present embodiments can be implemented.

FIG. 16 is a flowchart of an example method for encoding video data, according to which aspects of the present embodiments can be implemented.

FIG. 17 is a flowchart of an example method for decoding video data, according to which aspects of the present embodiments can be implemented.

### DETAILED DESCRIPTION

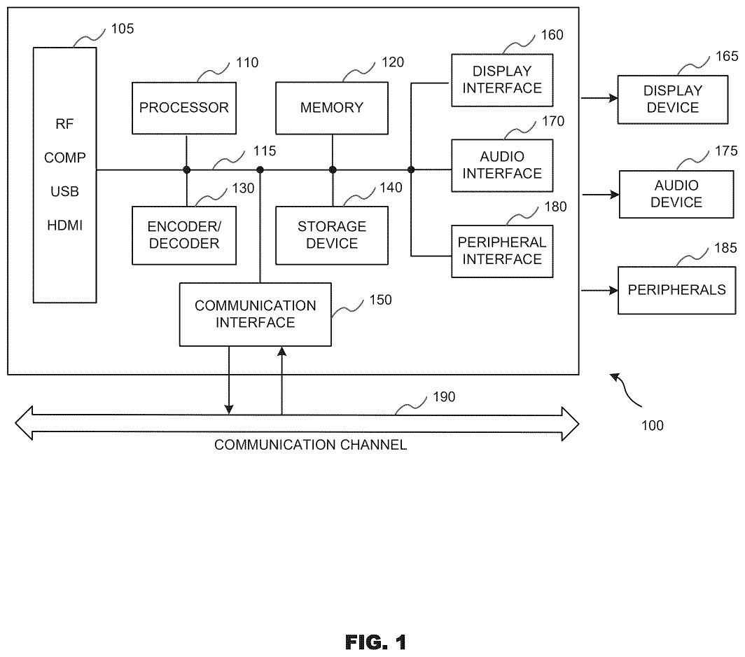

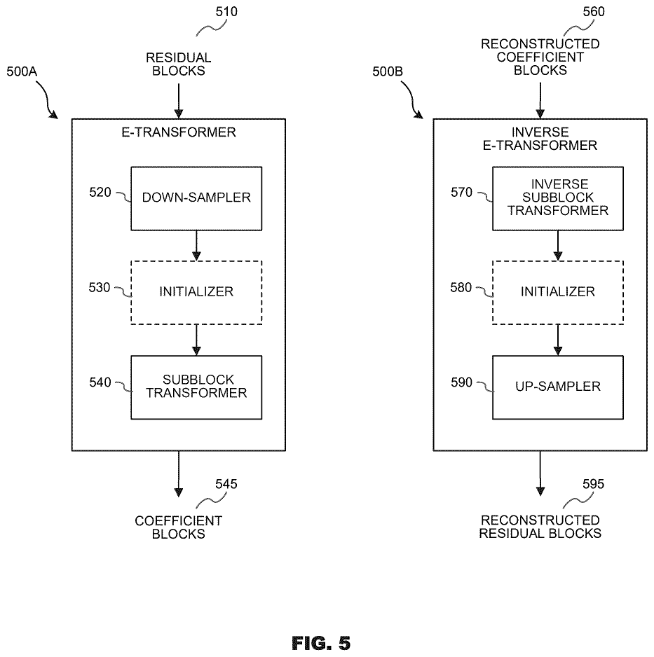

Systems and methods are disclosed herein for enhanced transform block coding. According to aspects described herein, a transform block (that is, a residual block or a partition thereof) is coded in an enhanced subblock transform (ESBT) mode or in a combined ESBT and subblock transform (SBT) modes, namely, a combined ESBT-SBT mode. In addition, the coding of the transform block, as disclosed herein, may be refined, utilizing both a base-layer coding and a refinement-layer coding. Traditional systems and methods for predictive video coding are described next in reference to FIGS. 1-4, followed by description of aspects of the present disclosure, described in reference to FIGS. 5-17.

FIG. 1 illustrates a block diagram of an example system 100. System 100 can be embodied as a device including the various components described below and can be configured to perform one or more of the aspects described in this application. Examples of such devices, include, but are not limited to, various electronic devices such as personal computers, laptop computers, smartphones, tablet computers, digital multimedia set-top boxes, digital television receivers, personal video recording systems, connected home appliances, and servers. Elements of system 100, singly or in combination, can be embodied in a single integrated circuit, multiple integrated circuits, and/or discrete components. For example, in at least one embodiment, the processing and encoder/decoder elements of system 100 are distributed across multiple integrated circuits and/or discrete components. In various embodiments, the system 100 is communicatively coupled to other systems, or to other electronic devices, via, for example, a communications bus or through dedicated input and/or output ports. In various embodiments, the system 100 is configured to implement one or more of the aspects described in this application.

The system 100 includes at least one processor 110 that can be configured to execute instructions loaded therein for implementing, for example, the various aspects described in this application. Processor 110 can include embedded memory, input and output interfaces, and various other circuitries as known in the art. The system 100 includes at least one memory 120 (e.g., a volatile memory device and/or a non-volatile memory device). System 100 includes a storage device 140, which can include non-volatile memory and/or volatile memory, including, for example, EEPROM, ROM, PROM, RAM, DRAM, SRAM, flash, magnetic disk drives, and/or optical disk drives. The storage device 140 can be an internal storage device, an attached storage device, and/or a network accessible storage device, for example.

System 100 includes an encoder/decoder module 130 configured to process data to provide encoded video data or decoded video data. The encoder/decoder module 130 can include its own processor and memory. The encoder/decoder module 130 represents module(s) that can be included in a device to perform encoding and/or decoding functions. Additionally, encoder/decoder module 130 can be implemented as a separate element of system 100 or can be incorporated within processor 110 as a combination of hardware and software as known to those skilled in the art.

Program code that is to be loaded into processor 110 or into encoder/decoder 130 to perform the various aspects described in this application can be stored in a storage device 140 and subsequently loaded into memory 120 for execution by processor 110. In accordance with various embodiments, one or more of processor 110, memory 120, storage device 140, and encoder/decoder module 130 can store one or more of various items during the performance of the processes described in this application. Such stored items can include, but are not limited to, the input video, the decoded video or portions of the decoded video, the bitstream, matrices, variables, intermediate or final results from the processing of equations, formulas, operations, and operational logic.

In several embodiments, memory inside of the processor 110 and/or the encoder/decoder module 130 is used to store instructions and to provide working memory for processing functions that are needed during encoding or decoding. In other embodiments, however, memory external to the processing device (where, for example, the processing device can be either the processor 110 or the encoder/decoder module 130) can be used for one or more of these functions. The external memory can be the memory 120 and/or the storage device 140 that may comprise, for example, a dynamic volatile memory and/or a non-volatile flash memory. In several embodiments, an external non-volatile flash memory is used to store the operating system of a television. In at least one embodiment, a fast external dynamic volatile memory such as a RAM is used as working memory for video coding and decoding operations.

The input to the elements of system 100 can be provided through various input devices as indicated in block 105. Such input devices include, but are not limited to, (i) an RF portion that receives an RF signal transmitted, for example, over the air by a broadcaster, (ii) a Composite input terminal (COMP), (iii) a USB input terminal, and/or (iv) an HDMI input terminal.

In various embodiments, the input devices of block 105 have associated respective input processing elements as known in the art. For example, the RF portion can be associated with elements suitable for (i) selecting a desired frequency (also referred to as selecting a signal, or band-limiting a signal to a band of frequencies), (ii) down-converting the selected signal, (iii) band-limiting again to a narrower band of frequencies to select, for example, a signal frequency band which can be referred to as a channel in certain embodiments, (iv) demodulating the down converted and band-limited signal, (v) performing error correction, and (vi) demultiplexing to select the desired stream of data packets. The RF portion of various embodiments includes one or more elements that perform these functions, for example, frequency selectors, signal selectors, band-limiters, channel selectors, filters, downconverters, demodulators, error correctors, and demultiplexers. The RF portion can include a tuner that performs some of these functions, including, for example, down-converting the received signal to a lower frequency (for example, an intermediate frequency or a near-baseband frequency) or to a baseband. In one set-top box embodiment, the RF portion and its associated input processing element receive an RF signal transmitted over a wired (for example, cable) medium, and perform frequency selection by filtering, down-converting, and filtering again to a desired frequency band. Various embodiments rearrange the order of the above-described (and other) elements, remove some of these elements, and/or add other elements performing similar or different functions. Added elements can include inserting elements in between existing elements, for example, inserting amplifiers and an analog-to-digital converter. In various embodiments, the RF portion includes an antenna.

Additionally, the USB and/or HDMI terminals can include respective interface processors for connecting system 100 to other electronic devices across USB and/or HDMI connections. It is to be understood that various aspects of input processing, for example, Reed-Solomon error correction, can be implemented, for example, within a separate input processing integrated circuit or within processor 110 as necessary. Similarly, aspects of USB or HDMI interface processing can be implemented within separate interface integrated circuits or within processor 110 as necessary. The demodulated, error corrected, and demultiplexed stream is provided to various processing elements, including, for example, processor 110, and encoder/decoder 130 operating in combination with the memory and storage elements to process the datastream as necessary for presentation on an output device.

Various elements of system 100 can be provided within an integrated housing. Within the integrated housing, the various elements can be interconnected and transmit data therebetween using a suitable connection arrangement 115, for example, an internal bus as known in the art, including the I2C bus, wiring, and printed circuit boards.

The system 100 includes communication interface 150 that enables communication with other devices via communication channel 190. The communication interface 150 can include, but is not limited to, a transceiver configured to transmit and to receive data over communication channel 190. The communication interface 150 can include, but is not limited to, a modem or network card. The communication channel 190 can be implemented, for example, within a wired and/or a wireless medium.

Data are streamed to the system 100, in various embodiments, using a Wi-Fi network such as IEEE 802.11. The Wi-Fi signal of these embodiments is received over the communication channel 190 and the communication interface 150 which are adapted for Wi-Fi communications. The communication channel 190 of these embodiments is typically connected to an access point or router that provides access to outside networks including the Internet for allowing streaming applications and other over-the-top communications. Other embodiments provide streamed data to the system 100 using a set-top box that delivers the data over the HDMI connection of the input block 105. Still other embodiments provide streamed data to the system 100 using the RF connection of the input block 105.

The system 100 can provide an output signal to various output devices, including a display device 165, an audio device (e.g., speaker(s)) 175, and other peripheral devices 185. The other peripheral devices 185 include, in various examples of embodiments, one or more of a stand-alone DVR, a disk player, a stereo system, a lighting system, and other devices that provide a function based on the output of the system 100. In various embodiments, control signals are communicated between the system 100 and the display device 165, the audio device 175, or other peripheral devices 185 using signaling such as AV.link, CEC, or other communication protocols that enable device-to-device control with or without user intervention. The output devices can be communicatively coupled to system 100 via dedicated connections through respective interfaces 160, 170, and 180. Alternatively, the output devices can be connected to system 100 using the communication channel 190 via the communication interface 150. The display device 165 and the audio device 175 can be integrated in a single unit with the other components of system 100 in an electronic device, for example, a television. In various embodiments, the display interface 160 includes a display driver, for example, a timing controller (T Con) chip.

The display device 165 and the audio device 175 can alternatively be separate from one or more of the other components, for example, if the RF portion of input 105 is part of a separate set-top box. In various embodiments in which the display device 165 and the audio device 175 are external components, the output signal can be provided via dedicated output connections, including, for example, HDMI ports, USB ports, or COMP outputs.

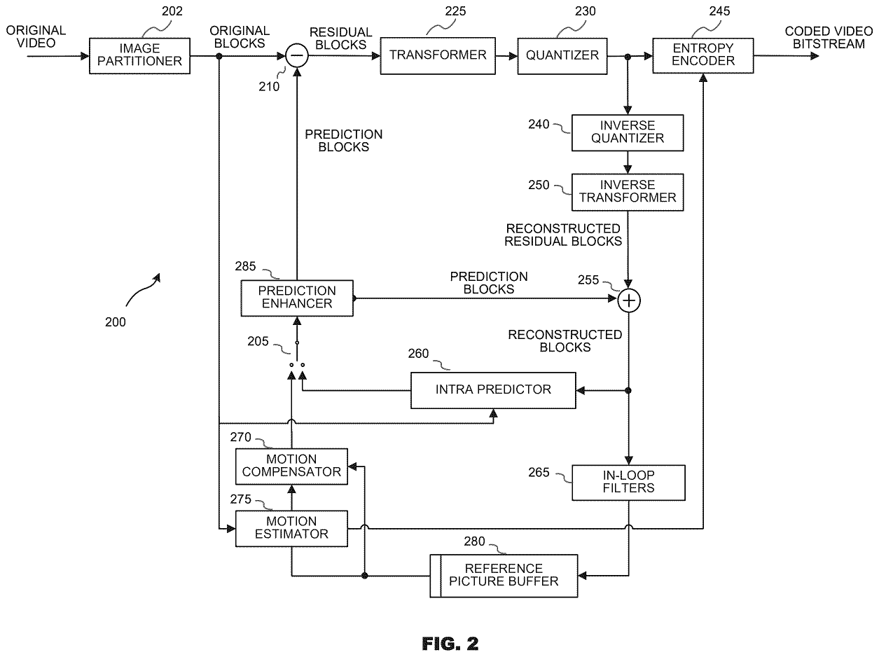

FIG. 2 illustrates a functional block diagram of an example video encoder 200. The video encoder 200 can be employed by the system 100 described in reference to FIG. 1. For example, the video encoder 200 can be an encoder that operates according to coding standards such as Advanced Video Coding (AVC, H.264/MPEG-4|ISO/IEC 14496-10), High Efficiency Video Coding (HEVC, ITU-T H.265|ISO/IEC 23008-2), or Versatile Video Coding (VVC, ITU-T H.266|ISO/IEC 23090-3).

Prior to undergoing encoding, the video data can be pre-processed by a precoding processor (not shown). Such pre-processing can include applying a color model transform to the input color picture (e.g., conversion from RGB 4:4:4 to YCbCr 4:2:0) or performing a mapping of the input picture in order to get a signal distribution that is more resilient to compression (for instance, applying a histogram equalizer and/or a denoising filter to one or more of the picture's components). The pre-processing can also include associating metadata with the video data that can be attached to the coded video bitstream.

In the encoder 200, a video frame is encoded by the encoder elements as generally described below. A picture of the original video to be encoded is partitioned into coding units (namely, original blocks) by an image partitioner 202. Typically, a coding unit (CU) contains a luminance block and respective chroma blocks, and so operations described herein as applied to a CU are applied to the luminance block and to the respective chroma blocks. Following partition 202, each CU can be encoded using an intra-prediction mode or an inter-prediction mode. In an intra-prediction mode, a prediction of the CU is performed by an intra predictor 260. In the intra-prediction mode, the content of a CU in a frame is predicted based on content from one or more other CUs of the same frame, using the other CUs' reconstructed version (available from the adder 255 output). In an inter-prediction mode, motion estimation and motion compensation are performed by a motion estimator 275 and a motion compensator 270, respectively. In the inter-prediction mode, the content of a CU in a frame is predicted based on content from one or more other CUs of neighboring frames, using the other CUs' reconstructed versions (available from the reference picture buffer 280). The encoder decides 205 which prediction result (one obtained through operations in the intra-prediction mode 260 or one obtained through operations in inter-prediction mode 270, 275) to use for encoding a CU, and indicates the selected prediction mode by, for example, a prediction mode flag. The selected prediction result may then be enhanced (e.g., filtered) by a prediction enhancer 285, outputting a respective prediction block. Following the prediction operation, a residual block is calculated for each CU, for example, by subtracting 210 the predicted CU from the original CU.

A CU's respective residual block or a partition thereof (also referred to herein as a transform block) is then transformed into a coefficient block by a transformer 225—that is, residual samples of the transform block are transformed into transform coefficients of the coefficient block. The resulting coefficient block is quantized by a quantizer 230. An entropy encoder 245 is next employed to entropy-encode into the bitstream the quantized coefficient block. In addition to entropy-encoding quantized coefficient blocks, motion vectors and other syntax elements are also entropy-encoded into the bitstream of the coded video data.

Along with the coding of CUs, as described above, the encoder 200 reconstructs the coded CUs to provide references for future predictions. Accordingly, quantized coefficient blocks (provided by the quantizer 230) are de-quantized, by an inverse quantizer 240, and then inverse transformed, by an inverse transformer 250, to reconstruct (decode) the residual blocks of respective CUs. Adding 255 the reconstructed residual blocks to respective prediction blocks results in respective reconstructed blocks of CUs. In-loop filters 265 can then be applied to the reconstructed picture (formed by the reconstructed blocks), performing, for example, deblocking filtering and/or sample adaptive offset (SAO) filtering to reduce encoding artifacts. The filtered reconstructed picture can then be stored in the reference picture buffer 280.

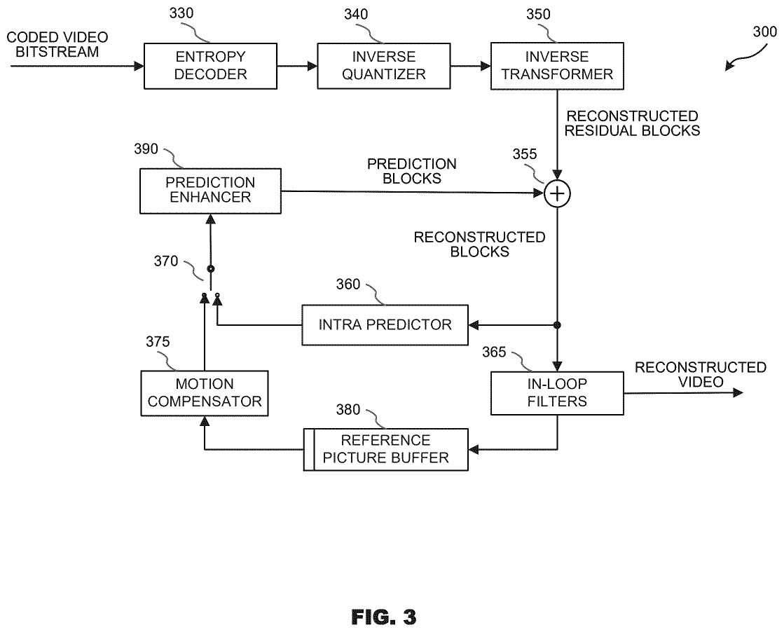

FIG. 3 illustrates a functional block diagram of an example video decoder 300. The video decoder 300 can be employed by the system 100 described in reference to FIG. 1. Generally, operational aspects of the video decoder 300 are reciprocal to operational aspects of the video encoder 200. As described in reference to FIG. 2, the encoder 200 also performs decoding operations 240, 250 through which the encoded pictures are reconstructed. The reconstructed pictures can then be stored in the reference picture buffer 280 and be used to facilitate motion estimation 275 and compensation 270, as explained above.

In the decoder 300, the bitstream of coded video data, generated by the video encoder 200, is first entropy-decoded by an entropy decoder 330, decoding from the bitstream the quantized coefficient blocks, motion vectors, and other control data that are encoded into the bitstream (such as data that indicate how the picture is partitioned and the CUs' selected prediction modes). The quantized coefficient blocks are de-quantized, by an inverse quantizer 340, and then inverse transformed, by an inverse transformer 350, to decode (reconstruct) the CUs' respective residual blocks. Adding 355 the reconstructed residual blocks to respective prediction blocks results in respective reconstructed blocks of CUs. Depending on a CU's selected prediction mode, a predicted CU can be obtained 370 from an intra predictor 360 or from a motion compensator 375 and may then be enhanced (e.g., filtered) by a prediction enhancer 390, generating a prediction block. In-loop filters 365 can be applied to the reconstructed picture (formed by the reconstructed blocks). The filtered reconstructed picture can then be stored in a reference picture buffer 380 to facilitate motion compensation 375.

A post-decoding processor (not shown) can further process the reconstructed video. For example, post-decoding processing can include an inverse color model transform (e.g., conversion from YCbCr 4:2:0 to RGB 4:4:4) or an inverse mapping to reverse the mapping process performed by the pre-encoding processor. The post-decoding processor can use metadata that were derived by the pre-encoding processor and/or were signaled in the decoded video bitstream.

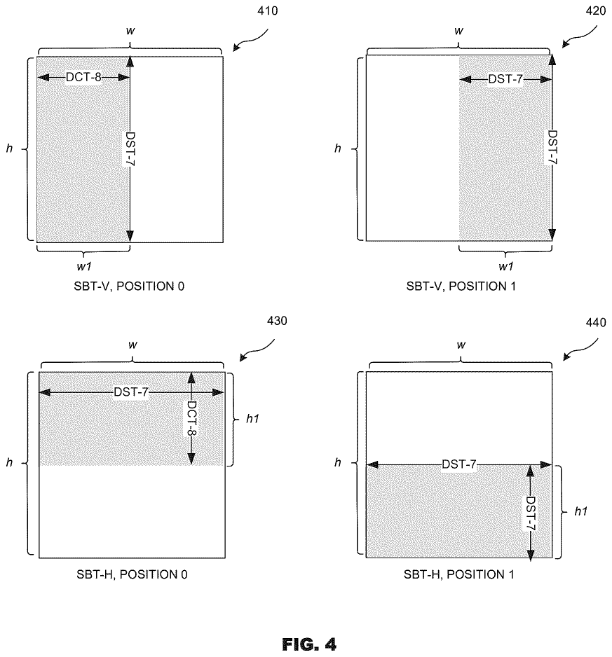

Aspects disclosed herein relate to coding and decoding of residual samples of transform blocks initially performed, respectively, by the transformer 225 of the encoder 200 (shown in FIG. 2) and by the inverse transformer 250, 350 of the encoder 200 and the decoder 300 (shown in FIG. 2 and FIG. 3). In the VVC standard, the transformer 225 can operate in a subblock transform (SBT) mode, where an SBT mode can be applied to CUs for which inter-prediction mode is used. When the transformer 225 operates in an SBT mode, only a subset of the residual samples that constitute a transform block are transformed (using an inferred adaptive transform), while the values of the remaining samples are set to zero. The coding of transform blocks in SBT mode, according to the VCC standard, is further described in reference to FIG. 4.

FIG. 4 illustrates transform block coding in an SBT mode. When an SBT mode is used, SBT-type and SBT-position information have to be signaled in the bitstream. FIG. 4 illustrates four combinations 410, 420, 430, 440 of SBT-types and SBT-positions, associated with a transform block of w width and h height. As illustrated, in an SBT-type of SBT-V, a block is split vertically 410, 420, where the subblock to be transformed can be the left subblock 410, in which case the SBT-position is 0. Otherwise, the subblock to be transformed can be the right subblock 420, in which case the SBT-position is 1. Similarly, in an SBT-type of SBT-H, a block is split horizontally 430, 440, where the subblock to be transformed can be the top subblock 430, in which case the SBT-position is 0. Otherwise, the subblock to be transformed can be the bottom subblock 440, in which case the SBT-position is 1. Thus, a vertical split 410, 420, SBT-V, splits the transform block into two parts: the first part (shaded region), of width w₁, is the part being transformed (referred to herein as subblock-1); and a second part (unshaded region), of width w-w₁, is the part set to zero (referred to herein as subblock-0). A horizontal split 430, 440, SBT-H, splits the transform block into two parts: the first part (shaded region), of height h₁, is the part being transformed (subblock-1); and a second part, of height h-h₁, is the part set to zero (subblock-0). Note that the splitting ratio may vary, that is, w₁ and h₁ may be a half of w and h, respectively (as demonstrated in FIG. 4), or may be a fourth of w and h.

In the VCC standard, for luma transform blocks, the choice of a transform type (i.e., a transform kernel) depends on the SBT-type and SBT-position information, while for chroma transform blocks, a DCT-2 transform kernel is used. As demonstrated in FIG. 4, for SBT-V 410 and SBT-H 430 at SBT-position 0, the DCT-8 and DST-7 transform kernels are used to transform subblock-1, while for SBT-V 420 and SBT-H 440 at SBT-position 1, the DST-7 transform kernel is used to transform subblock-1. When one dimension of the transform block is greater than 32, DCT-2 transform is used for both dimensions. In summary, in the VCC standard, the following parameters are supported to define coding in an SBT mode: 1) an SBT-type of a vertical (SBT-V) or a horizontal (SBT-H) split; 2) an SBT-position at a left/top position (SBT-position 0) or at a right/bottom position (SBT-position 1); and 3) a splitting ratio of a half (H) or a quarter (Q).

Table 1 illustrates VVC signaling of coding in an SBT mode. The signaling of transform block coding in SBT mode, according to the VVC standard, is at the CU level. In Table 1, the syntax code that is related to SBT mode is highlighted in italics. As shown, in an SBT mode, the SBT-type is signaled using cu_sbt_horizontal_flag, the SBT-position is signaled using cu_sbt_pos_flag, and the splitting ratio is signaled using cu_sbt_quad_flag. Table 1 shows that SBT mode is disabled for some specific block dimensions, the disabling depending also on the splitting ratio (H or Q). Table 1 also shows that when an SBT mode is activated, mts_idx (Multiple Transform Selection index, which is used to indicate the transform kernel) is not signaled, which means that the used transform kernel can be inferred from the signaling of the SBT-type, the SBT-position, and the splitting ratio.

TABLE 1
VVC signaling of coding in an SBT mode.

| | |
|---|---|
| if( cu_coded_flag ) { | |
| if( CuPredMode[ chType ][ x0 ][ y0 ] = = MODE_INTER && | |
| sps_{—}sbt_{—}enabled_{—}flag && | |
| !ciip_flag[ x0 ][ y0 ] && cbWidth <= MaxTbSizeY && | |
| cbHeight <= MaxTbSizeY ) { | |
| allowSbtVerH = cbWidth >= 8 | |
| allowSbtVerQ = cbWidth >= 16 | |
| allowSbtHorH = cbHeight >= 8 | |
| allowSbtHorQ = cbHeight >= 16 | |
| if( allowSbtVerH \| \| allowSbtHorH ) | |
| cu_{—}sbt_{—}flag | ae(v) |
| if( cu sbt flag ) { | |
| if( ( allowSbtVerH \| \| allowSbtHorH ) && ( allowSbtVerQ \| \| | |
| allowSbtHorQ ) ) | |
| cu_{—}sbt_{—}quad_{—}flag | ae(v) |
| if( ( cu_{—}sbt_{—}quad_{—}flag && allowSbtVerQ && allowSbtHorQ ) \| \| | |
| ( !cu sbt quad flag && allowSbtVerH && allowSbtHorH ) ) | |
| cu_{—}sbt_{—}horizontal_{—}flag | ae(v) |
| cu_{—}sbt_{—}pos_{—}flag | ae(v) |
| } | |
| } | |
| ... | |
| if( treeType != DUAL_TREE_CHROMA && lfnst_idx = = 0 && | |
| transform_skip_flag[ x0 ][ y0 ][ 0 ] = = 0 && | |
| Max( cbWidth, cbHeight ) <= 32 && | |
| IntraSubPartitionsSplitType = = ISP_NO_SPLIT && | |
| cu_{—}sbt_{—}flag = = 0 && | |
| MtsZeroOutSigCoeffFlag = = 1 && MtsDcOnly = = 0 ) { | |
| if( ( ( CuPredMode[ chType ][ x0 ][ y0 ] = = MODE_INTER && | |
| sps_explicit_mts_inter_enabled_flag ) \| \| | |
| ( CuPredMode[ chType ][ x0 ][ y0 ] = = MODE_INTRA && | |
| sps_explicit_mts_intra_enabled_flag ) ) ) | |
| mts_idx | ae(v) |
| } | |

The accuracy of coding a video block in an SBT mode is content dependent. That is, coding accuracy depends on the pattern distribution of the residual samples in the transform block. Generally, simply zeroing a half (or three quarters) of the transform block may remove important details. In practice, the SBT mode is applied to transform blocks with residual samples that have specific properties (e.g., where most of the residual signal energy is concentrated on one side of the block). Aspects disclosed herein provide for an enhanced SBT mode that improves the coding performance under this mode, referred to herein as an ESBT mode. As disclosed herein, the ESBT mode may be used to replace the existed SBT mode or may be used in combination with the SBT mode. Furthermore, the ESBT mode may be applied to CUs that are predicted using an intra-prediction mode, an inter-prediction mode, or a combined (intra- and inter-) prediction mode. Aspects of the ESBT mode are described below in reference to FIGS. 5-17.

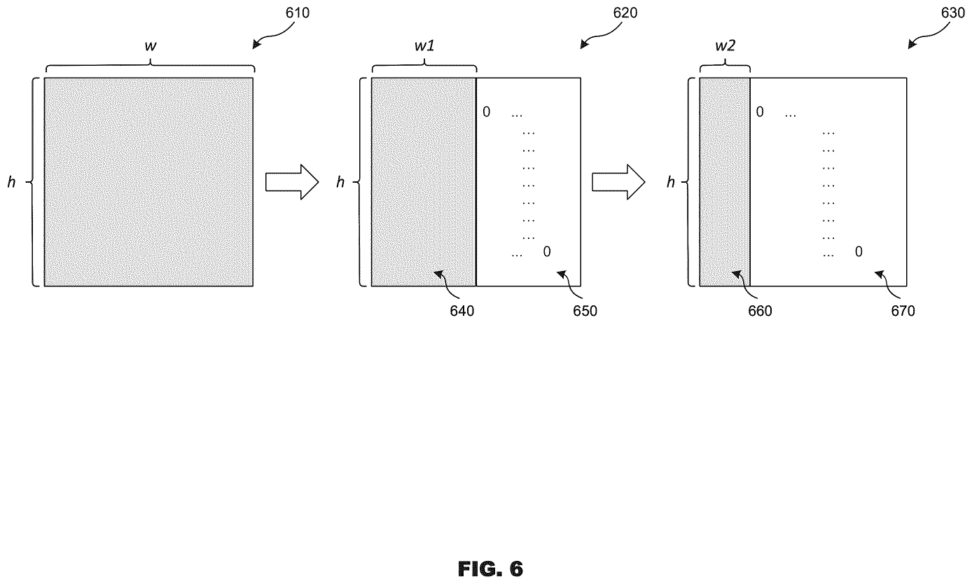

FIG. 5 is a functional block diagram of an example enhanced transformer 500A and an example inverse enhanced transformer 500B. According to aspects described herein, the enhanced transformer (i.e., e-transformer) 500A can be employed instead of the transformer 225 in the encoder 200 of FIG. 2. The inverse enhanced transformer (i.e., inverse e-transformer) 500B can be employed instead of the inverse transformer 250, 350 in the encoder 200 and in the decoder 300 of FIG. 2 and FIG. 3, respectively. The e-transformer 500A and the inverse e-transformer 500B are configured to code a transform block using an ESBT mode or using a combination of ESBT and SBT modes, as described herein. As shown in FIG. 5, the e-transformer 500A receives residual blocks 510 (an output of subtractor 210 in encoder 200) and generates therefrom respective coefficient blocks 545 (to be next quantized by the quantizer 230). The inverse e-transformer 500B receives reconstructed coefficient blocks 560 (an output of the inverse quantizer 240 in encoder 200 or the inverse quantizer 340 in decoder 300) and generates therefrom reconstructed residual blocks 595 (to be next added to respective prediction blocks by the adder 255, 355). Aspects of operation of the e-transformer 500A and the inverse e-transformer 500B are further described below in reference to FIG. 5 and FIG. 6.

The process employed by the e-transformer 500A, operating in an ESBT mode, begins with the down-sampling, by a down-sampler 520, of a transform block 610 (that is, a residual block 510 or a part thereof). As illustrated in FIG. 6, the transform block 610 is of w width and h height. Following the down-sampling, transform block 620 is formed, containing the down-sampled transform block that constitutes subblock-1 (shaded region) 640. The other part of the transform block 620 may be initialized, by an initializer 530, for example, into a constant value such as a zero value, and constitutes subblock-0 (unshaded region) 650. Next, a subblock transformer 540 can be employed to transform subblock-1 640, resulting in a coefficient block (of coefficient blocks 545). The process employed by the inverse e-transformer 500B generally reverses the operation of the e-transformer 500A. Accordingly, a coefficient block (of the reconstructed coefficient blocks 560) is first inverse transformed, by an inverse subblock transformer 570, resulting in a reconstructed subblock-1. The corresponding subblock-0 may be initialized, by an initializer 580, operating as the initializer 530 of the e-transformer 500A. The reconstructed subblock-1 is then up-sampled, by an up-sampler 590, generating a reconstructed transform block (that is, a reconstructed residual block 595 or a part thereof). In an aspect, the operation of the initializer 530 precedes the operation of the down-sampler 520 in the e-transformer 500A, and the operation of the up-sampler 590 precedes the operation of the initializer 580 in the inverse e-transformer 500B.

Hence, coding a transform block in an ESBT mode may comprise the down-sampling 520, the initialization 530, and the transforming 540 processes performed by the e-transformer 500A, as described herein. In an aspect, the e-transformer may code a transform block using a combination of ESBT and SBT modes, namely, a combined ESBT-SBT mode. To that end, as illustrated by transform block 630 of FIG. 6, the initialization process 530 may be extended by further initializing part of the down-sampled transform block (subblock-1 640)—effectively reducing the width of subblock-1 640 from w₁ to w₂. Thus, in a combined ESBT-SBT mode, only a portion of the down-sampled transform block is transformed (subblock-1 660), while the remaining portion of the down-sampled transform block may be initialized, resulting in an extended subblock-0 670. The reduced subblock-1 660 is transformed by the subblock transformer 540 and reconstructed by the inverse subblock transformer 570, as described above.

In the example of FIG. 6, the sampling is illustrated to be in the horizontal direction, reducing the number of samples by two (that is, a sampling ratio of two). The same process (as employed by the e-transformer 500A and the inverse e-transformer 500B) can be applied using different sampling ratios in the vertical direction or in both the vertical and the horizontal directions. In an aspect, a set of possible sampling ratios can be predefined by default and/or can be signaled in the bitstream. Different sets of sampling ratios may be used for luma and chroma residual samples. Furthermore, the set of possible sampling ratios may be based on the quantization parameters (QP) used by the quantizer 230 to quantize the coefficient blocks 545 (and by the inverse quantizer 240, 340 to dequantize the quantized coefficient blocks). For example, for low QP levels (corresponding to high bitrates), such as QP levels below 32, a sampling ratio of ½ may be considered. While, for high QP levels (corresponding to low bitrates), such as QP levels equal or above 32, sampling ratios ½ or ¼ may be considered. In another aspect, the sampling ratio may be based on parameters such as SBT-type and SBT-position, defined for an SBT mode; the sampling ratio may be inferred from the signaled SBT-type and SBT-position. For example, SBT-type of SBT-V and SBT-position of 0 value can be used to infer sampling in the horizontal direction with a sampling ratio of 4, where the down-sampled transform block resides in the left quarter of the transform block (that is, an alternative subblock-1 640, where w₁=w/4).

The filters used as part of the down-sampling and the up-sampling processes, respectively employed by the down-sampler 520 and the up-sampler 590, may vary depending on the coding context and the coding parameters. For example, these filters may be determined based on one or more factors such as: the quantization parameters (QP) used to quantize and dequantize the coefficient blocks, the prediction mode (intra or inter) used to code the respective CU, the color component type, the image pattern in the CU's neighborhood (e.g., the level of image variance, the amplitude of image gradients), the transform block vertical and/or horizontal dimensions, or the transform kernel applied to the residual samples of the transform block.

In an aspect, the encoder 200 may select to use an SBT mode, an ESBT mode, or a combined ESBT-SBT mode in the coding of a transform block based on a result obtained from a testing process. The testing process may afford the encoder 200 the coding of more transform blocks in these modes. The testing process may employ various filters to filter the residual samples or the down-sampled residual samples to determine, based on a coding cost measure for example, whether an SBT mode, an ESBT mode, or a combined ESBT-SBT mode should be used in the coding of a respective transform block. The applied filters may be, for example, mean or gaussian filters (applied to remove high frequencies), median filters (effective at removing salt and paper noise), or bilateral filters (effective at noise removal while preserving the edges).

As described above, according to aspects, the transformer 225 of the encoder 200 can be replaced by the e-transformer 500A and the inverse transformer 250 of the encoder 200 can be replaced by the inverse e-transformer 500B. In another aspect, only the inverse transformer 250 is replaced by the inverse e-transformer 500B. In this aspect, the original blocks and the respective prediction blocks (at the input to the subtractor 210) are first down-sampled and then subtracted 210 from each other, generating respective residual blocks to be transformed by the transformer 225. In a variant, in a case where an original block is predicted using an inter-prediction mode, down-sampling the respective prediction block can be part of the motion compensation operation, performed by the motion compensator 270, as is done, in the VVC standard, by the “Reference Resampling Picture” (RPR) process.

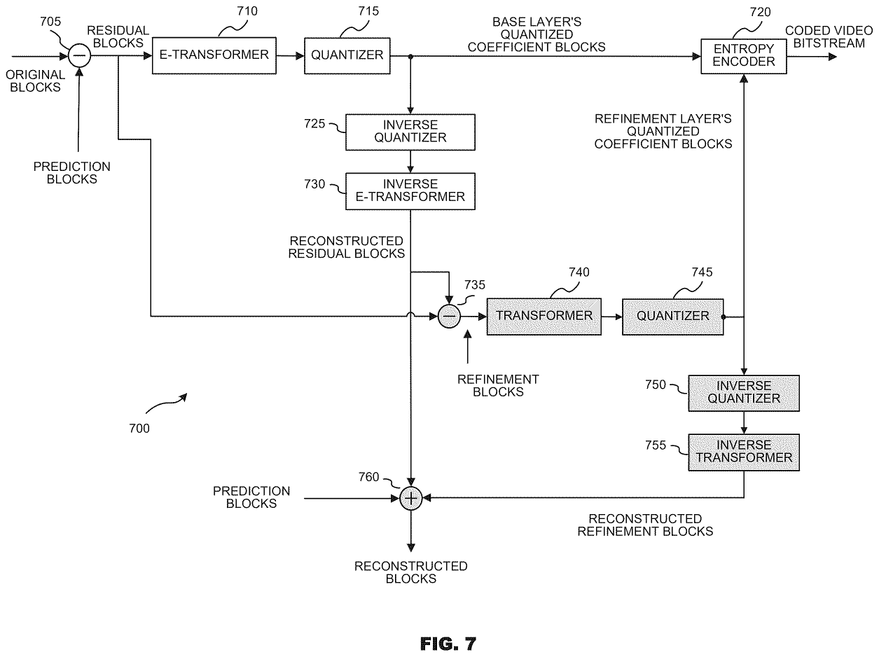

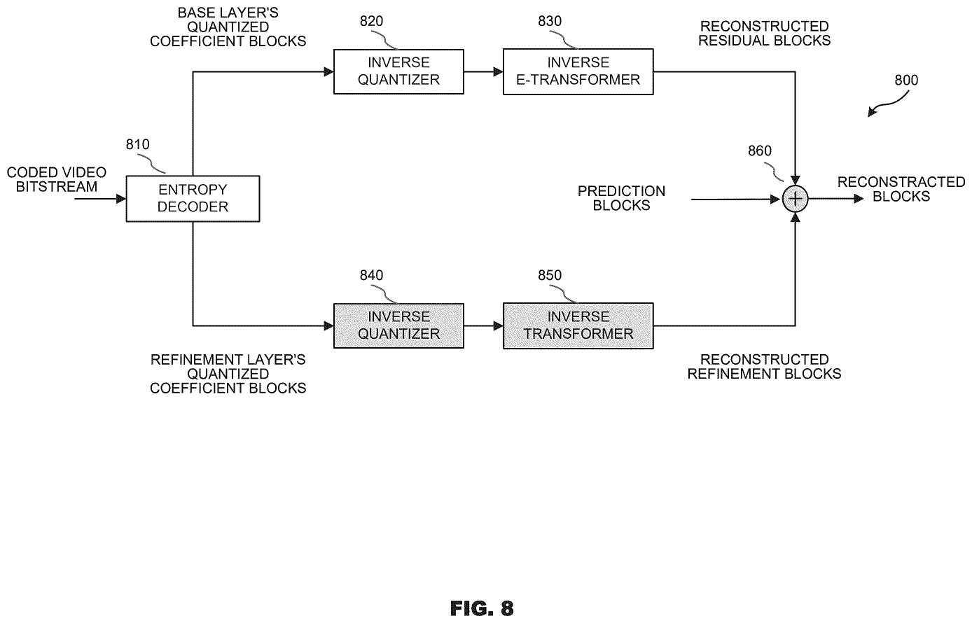

In an aspect, coding the residual samples of a transform block, by the e-transformer 500A, may be followed by a refinement step in which differences between residual samples and respective reconstructed residual samples are further coded. That is, a transform block may be first coded using a base-layer coding. Then, using a refinement-layer coding, a refinement block—that is, the difference between the transform block and the respective reconstructed transform block (reconstructed by the base-layer) is coded. For example, the base-layer coding may be implemented by the e-transformer 500A (e.g., operating in an ESBT mode or a combined ESBT-SBT mode) to code transform blocks and the refinement-layer coding may be implemented by the transformer 225 (e.g., conventionally operating, where no SBT mode, ESBT mode, or combined ESBT-SBT mode is applied) to code respective refinement blocks. An encoder and a decoder, including a refinement-layer, are further described in reference to FIG. 7 and FIG. 8.

FIG. 7 is a functional block diagram of an example video encoder with dual layer coding 700. The encoder 700 of FIG. 7 is an enhanced version of the encoder 200 of FIG. 2. Relative to encoder 200, encoder 700 uses e-transformer 710 (i.e., 500A) instead of transformer 225, inverse e-transformer 730 (i.e., 500B) instead of inverse transformer 250, and additionally includes a refinement-layer (shaded components 735, 740, 745, 750, 755, and 760). Note that not all the components shown in FIG. 2 appear in FIG. 7 (for clarity of presentation, components 202, 205, 260, 265, 270, 275, 280, and 285 are not presented in FIG. 7).

As shown in FIG. 7, in a base-layer coding, the e-transformer 710 receives a residual block—the difference between an original block and a respective prediction block, outputted by the subtractor 705. The e-transformer 710 transforms a transform block (the residual block or a part thereof), generating a transform coefficient block associated with the first coding layer. The coefficient block is then quantized by the quantizer 715 that delivers the base-layer's quantized coefficient block to the entropy coder 720. The base-layer's quantized coefficient block is also delivered to the inverse quantizer 725 that dequantizes that coefficient block. The inverse e-transformer 730 reverses the operation of the e-transformer 710, generating a reconstructed transform block (a reconstructed residual block or a part thereof) of the base-layer. The refinement coding layer (shaded components) then operates on a refinement block—the difference 735 between the base-layer's reconstructed residual block and the residual block (obtained by the subtractor 705). Thus, the refinement block is transformed, by the transformer 740, and next quantized, by the quantizer 745, generating a quantized coefficient block, delivered to the entropy coder 720. The refinement-layer's quantized coefficient block is also delivered to the inverse quantizer 750 that dequantizes that coefficient block. The inverse transformer 755 next reverses the operation of the transformer 740, generating a reconstructed refinement block. The reconstructed residual block (reconstructed by the base-layer) and the reconstructed refinement block (reconstructed by the refinement-layer) are then added 760 to the respective prediction block, resulting in a reconstructed original block.

FIG. 8 is a functional block diagram of an example video decoder with dual layer decoding 800. The decoder 800 of FIG. 8 is an enhanced version of the decoder 300 of FIG. 3. Relative to decoder 300, decoder 800 uses inverse e-transformer 830 (i.e., 500B) instead of inverse transformer 350, and additionally includes a refinement-layer (shaded components 840, 850, and 860). Note that not all the components shown in FIG. 3 appear in FIG. 8 (for clarity of presentation, components 360, 365, 370, 375, 380, and 390 are not presented in FIG. 8).

The decoder 800 generally reverses the operation of the encoder 700 and may be configured to independently decode the residual blocks of the base-layer and the refinement-layer. The decoder 800 first entropy decodes 810 from the bitstream a quantized coefficient block of the base-layer and a quantized coefficient block of the refinement-layer. In a base decoding layer, an inverse quantizer 820 dequantizes the coefficient block of the base-layer, feeding the dequantized coefficient block to an inverse e-transformer 830. The inverse e-transformer 830 next reverses the operation of the e-transformer 710 (as described herein in reference to 500B of FIG. 5), transforming the received dequantized coefficient block into a reconstructed transform block (a reconstructed residual block or a part thereof). In a refinement decoding layer, an inverse quantizer 840 dequantizes the coefficient block of the refinement-layer, feeding the dequantized coefficient block to an inverse transformer 850. The inverse transformer 850 next reverses the operation of the transformer 740, transforming the received coefficient block into a reconstructed refinement block. The reconstructed residual block (reconstructed by the base-layer) and the reconstructed refinement block (reconstructed by the refinement-layer) are then added 860 to the respective prediction block, resulting in a reconstructed block.

The transform kernels, used by the transformers and the reverse transformers in the base and in the refinement-layers, may be the same or may be different. For example, a predefined set of transform kernels may be used in the base-layer (by the e-transformer 710 and by the inverse e-transformers 730, 830), while another predefined set of transform kernels may be used in the refinement-layer (by the transformer 740 and the inverse transformers 755, 850). For example, the VVC MTS set of transform kernels may be used in the base-layer while the DCT-2 kernel may be used in refinement-layer.

Table 2 illustrates signaling of coding in an ESBT mode based on the signaling of coding in an SBT mode. According to aspects, the use of an ESBT mode and its associated parameters can be signaled in the bitstream or can be inferred. In an aspect, syntax used to signal an SBT mode can be used to signal an ESBT mode for applications where an SBT mode is not utilized. As shown in Table 2, the coding of a transform block in an ESBT mode can be signaled using syntax element cu_sbt_flag. The direction of the down sampling can be signaled using syntax element cu_sbt_horizontal_flag. And the sampling ratio of the down sampling can be signaled using syntax element cu_sbt_quad_flag. Note that there is no need to indicate the position of subblock-1 that contains the down-sampled residual samples (that is, the subblock the coefficient block is associated with) since it can be inferred from the cu_sbt_horizontal_flag whether this subblock's position is on the left or on the top of the transform block. Therefore, in the example of Table 2, cu_sbt_pos_flag (used in the signaling syntax of Table 1) has been removed.

TABLE 2
Signaling of coding in an ESBT mode based
on the signaling of coding in an SBT mode.

| | |
|---|---|
| if( cu_coded_flag ) { | |
| if( CuPredMode[ chType ][ x0 ][ y0 ] = = MODE_INTER && | |
| sps_sbt_enabled_flag && | |
| !ciip_flag[ x0 ][ y0 ] && cbWidth <= MaxTbSizeY && | |
| cbHeight <= MaxTbSizeY ) { | |
| allowSbtVerH = cbWidth >= 8 | |
| allowSbtVerQ = cbWidth >= 16 | |
| allowSbtHorH = cbHeight >= 8 | |
| allowSbtHorQ = cbHeight >= 16 | |
| if( allowSbtVerH \| \| allowSbtHorH ) | |
| cu_sbt_flag | ae(v) |
| if( cu_sbt_flag ) { | |
| if( ( allowSbtVerH \| \| allowSbtHorH ) && | |
| ( allowSbtVerQ \| \| allowSbtHorQ ) ) | |
| cu_sbt_quad_flag | ae(v) |
| if( ( cu_sbt_quad_flag && allowSbtVerQ && allowSbtHorQ ) \| \| | |
| ( !cu_sbt_quad_flag && allowSbtVerH && allowSbtHorH ) ) | |
| cu_sbt_horizontal_flag | ae(v) |
| } | |
| } | |
| ... | |

Table 3 illustrates a modified syntax that can be used to signal the coding of a transform block in an ESBT mode or in an SBT mode. In the example of Table 3, the use of an ESBT mode is indicated by a new flag, cu_sbt_resampling_flag. As in the example of Table 2, when signaling the coding of a transform block in an ESBT mode, there is no need to signal the position (that is, cu_sbt_pos_flag is not signaled) since the position can be implicitly inferred as the left subblock or the top subblock, depending on cu_sbt_horizontal_flag.

TABLE 3
Signaling of coding in an ESBT mode or an SBT mode.

| | |
|---|---|
| if( cu_coded_flag ) { | |
| if( CuPredMode[ chType ][ x0 ][ y0 ] = = MODE_INTER && | |
| sps_sbt_enabled_flag && | |
| !ciip_flag[ x0 ][ y0 ] && cbWidth <= MaxTbSizeY && | |
| cbHeight <= MaxTbSizeY ) { | |
| allowSbtVerH = cbWidth >= 8 | |
| allowSbtVerQ = cbWidth >= 16 | |
| allowSbtHorH = cbHeight >= 8 | |
| allowSbtHorQ = cbHeight >= 16 | |
| if( allowSbtVerH \| \| allowSbtHorH ) | |
| cu_sbt_flag | ae(v) |
| if( cu_sbt_flag ) { | |
| cu_{—}sbt_{—}resampling_{—}flag | ae(v) |
| if( ( allowSbtVerH \| \| allowSbtHorH ) && | |
| ( allowSbtVerQ \| \| allowSbtHorQ ) ) | |
| cu_sbt_quad_flag | ae(v) |
| if( ( cu_sbt_quad_flag && allowSbtVerQ && allowSbtHorQ ) \| \| | |
| ( !cu_sbt_quad_flag && allowSbtVerH && allowSbtHorH ) ) | |
| cu_sbt_horizontal_flag | ae(v) |
| if( cu sbt resampling flag = = 0 ) | |
| cu_sbt_pos_flag | ae(v) |
| } | |
| } | |
| ... | |

Table 4 illustrates a modified syntax that can be used to signal the coding of a transform block in a combined ESBT-SBT mode (as described above in reference to block 630 in FIG. 6). As illustrated in Table 4, when cu_sbt_resampling_flag is true, syntax elements cu_sbt_resampling_horizontal_ratio and cu_sbt_resampling_vertical_ratio can be used to signal the horizontal and the vertical sampling ratios (shown in italics). In this mode, the portion of the down-sampled transform block 640 that is initialized (to form block 660) can be signaled using syntax element cu_sbt_quad_flag.

TABLE 4
Signaling of coding in a combined ESBT-SBT mode.

| | |
|---|---|
| if( cu_coded_flag ) { | |
| if( CuPredMode[ chType ][ x0 ][ y0 ] = = MODE_INTER && | |
| sps_sbt_enabled_flag && | |
| !ciip_flag[ x0 ][ y0 ] && cbWidth <= MaxTbSizeY && | |
| cbHeight <= MaxTbSizeY ) { | |
| allowSbtVerH = cbWidth >= 8 | |
| allowSbtVerQ = cbWidth >= 16 | |
| allowSbtHorH = cbHeight >= 8 | |
| allowSbtHorQ = cbHeight >= 16 | |
| if( allowSbtVerH \| \| allowSbtHorH ) | |
| cu_sbt_flag | ae(v) |
| if( cu_sbt_flag) { | |
| if( ( allowSbtVerH \| \| allowSbtHorH ) && | |
| ( allowSbtVerQ \| \| allowSbtHorQ ) ) | |
| cu_sbt_quad_flag | ae(v) |
| if( ( cu_sbt_quad_flag && allowSbtVerQ && allowSbtHorQ ) \| \| | |
| ( !cu_sbt_quad_flag && allowSbtVerH && allowSbtHorH ) ) | |
| cu_sbt_horizontal_flag | ae(v) |
| cu_sbt_pos_flag | ae(v) |
| } | |
| cu_{—}sbt_{—}resampling_{—}flag | ae(v) |
| if( cu sbt resampling flag) { | |
| cu_{—}sbt_{—}resampling_{—}horizontal_{—}ratio | ae(v) |
| cu_{—}sbt_{—}resampling_{—}vertical_{—}ratio | ae(v) |
| } | |
| } | |
| ... | |

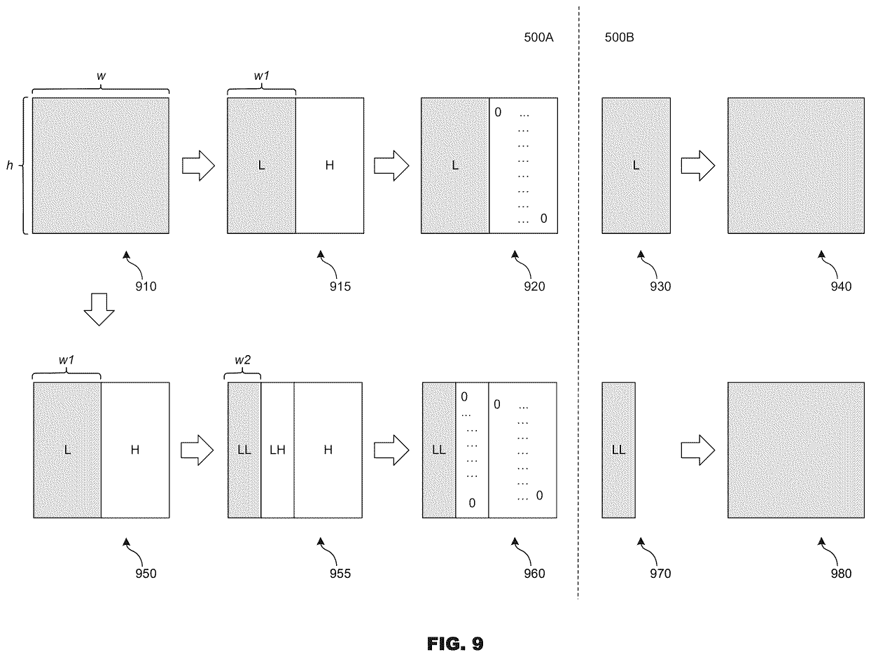

FIG. 9 illustrates transform block coding, utilizing a wavelet transform 900. According to aspects, the e-transformer 500A and the inverse e-transformer 500B may use a wavelet transform to transform and to reconstruct a transform block. The benefit of using a wavelet transform is in that the down-sampling 520 and the up-sampling 590 operations are inherently performed by the wavelet transformation and the wavelet reconstruction, respectively (in addition to other benefits that are generally provided by wavelet representations). As illustrated in FIG. 9, when applying a wavelet transform to residual samples of a transform block 910, the transformation results in a coefficient block 915, containing low-band coefficients (shaded area, denoted L) and high-band coefficients (unshaded area, denoted H). The high-band coefficients represent high frequency content (details), and, typically, have lower energy relative to the low-band coefficients. Therefore, the residual samples in the transform block 910 can be approximated by setting the high-band coefficients (H) to a constant value, such as zero, as illustrated 920, and so only the low-band coefficients (L) are used to represent the residual samples of the transform block 910. To reconstruct the transform block based on the low-band coefficients 930, inverse wavelet transform is applied that generates a reconstructed transform block 940. When the content of the transform block 910 is relatively smooth, setting the high-band coefficient to zero 920 is unlikely to introduce a perceptive error in the reconstructed block 940. Hence, in an aspect, the wavelet transform process 910-920 embodies the operations of the down-sampler 520, the initializer 530, and the subblock transformer 540 of the e-transformer 500A; and the inverse wavelet transform process 930-940 embodies the operations of the inverse subblock transformer 570, the initializer 580, and the up-sampler 590 of the inverse e-transformer 500B.

Hence, a wavelet transform can be employed to implement the operations of the e-transformer 500A and the inverse e-transformer 500B. Any wavelet transform may be used (e.g., Haar or Daubechies wavelets) in the horizontal dimension and/or the vertical dimension and may be applied iteratively. For example, one wavelet iteration, applied horizontally (corresponding to a vertical split and a half sampling ratio) is demonstrated by blocks 910-940 of FIG. 9. Two wavelet iterations applied horizontally (corresponding to a vertical split and a fourth sampling ratio) is demonstrated by blocks 910 and 950-980 of FIG. 9. In the latter, a first application of the wavelet transform to the residual samples of the transform block 910 results in a coefficient block 950, containing low-band coefficients (shaded area, denoted L) and high-band coefficients (unshaded area, denoted H). A second application of the wavelet transform to the low-band coefficients in the coefficient block 950 (L) results in a coefficient block 955, containing low-band coefficients (shaded area, denoted LL) and high-band coefficients (unshaded area, denoted LH), in addition to the high-band coefficients obtained in the first iteration (unshaded area, denoted H). Next, the high band coefficients obtained through the two iterations (LH and H) are set to zero, and only the low-band coefficients (LL) are used to represent the residual samples of the transform block 910. To reconstruct the transform block based on the low-band coefficients LL 970, inverse wavelet transform is applied, in two iterations, that generates a reconstructed transform block 980.

Accordingly, the dimension of the subblock that is used to represent the residual samples of the transform block 910 (e.g., w₁ of L 915 or w₂ of LL 955) may be determined by the number of iterations with which the wavelet transform is applied, referred to herein as the wavelet depth. Thus, in the examples of FIG. 9, the application of a horizontal wavelet of a depth of 1 is illustrated by blocks 910-940 of FIG. 9 and the application of a horizontal wavelet of a depth of 2 is illustrated by blocks 910 and 950-980 of FIG. 9. According to aspects, the wavelet transform can be applied independently in the horizontal and in the vertical dimensions, and different wavelet depths may be applied in each dimension.

Table 5 illustrates the signaling of a wavelet depth and a filter type. The signaling of the wavelet depth in the horizontal and the vertical dimensions may be based on syntax elements similar to cu_sbt_resampling_horizontal_ratio and cu_sbt_resampling_vertical_ratio; where a ratio of ½ corresponds to a depth of 1 and a ratio of ¼ corresponds to a depth of 2. Alternatively, the depth may be explicitly signaled, for instance, using syntax elements cu_sbt_resampling_horizontal_depth and cu_sbt_resampling_vertical_depth. In a variant, the type of wavelet filter may be signaled. For instance, syntax element cu_sbt_resampling_filter_type may be signaled to indicate which type of wavelet filter is used. An example of syntax is provided in Table 5.

TABLE 5
Signaling of wavelet depth and filter type.

| | |
|---|---|
| if( cu_coded_flag ) { | |
| if( CuPredMode[ chType ][ x0 ][ y0 ] = = MODE_INTER && | |
| sps_sbt_enabled_flag && | |
| !ciip_flag[ x0 ][ y0 ] && cbWidth <= MaxTbSizeY && | |
| cbHeight <= MaxTbSizeY ) { | |
| allowSbtVerH = cbWidth >= 8 | |
| allowSbtVerQ = cbWidth >= 16 | |
| allowSbtHorH = cbHeight >= 8 | |
| allowSbtHorQ = cbHeight >= 16 | |
| if( allowSbtVerH \| \| allowSbtHorH ) | |
| cu_sbt_flag | ae(v) |
| if( cu_sbt_flag) { | |
| if( ( allowSbtVerH \| \| allowSbtHorH ) && | |
| ( allowSbtVerQ \| \| allowSbtHorQ ) ) | |
| cu_sbt_quad_flag | ae(v) |
| if( ( cu_sbt_quad_flag && allowSbtVerQ && allowSbtHorQ ) \| \| | |
| ( !cu_sbt_quad_flag && allowSbtVerH && allowSbtHorH ) ) | |
| cu_sbt_horizontal_flag | ae(v) |
| cu_sbt_pos_flag | ae(v) |
| } | |
| cu_{—}sbt_{—}resampling_{—}flag | ae(v) |
| if( cu sbt resampling flag) { | |
| cu_{—}sbt_{—}resampling_{—}filter_{—}type | ae(v) |
| cu_{—}sbt_{—}resampling_{—}horizontal_{—}depth | ae(v) |
| cu_{—}sbt_{—}resampling_{—}vertical_{—}depth | ae(v) |
| } | |
| } | |

Table 6 illustrates signaling the coding of a transform block in a refinement mode (as demonstrated by the dual layer coding and decoding of FIG. 7 and FIG. 8). A new flag cu_refinement_flag is used to indicate whether the coding of residual samples of a transform block is refined or not. When this flag is true, a refinement mode is invoked by calling a function, named refinement_transform_tree( ).

TABLE 6
Signaling of coding in a refinement mode.

| | |
|---|---|
| if( cu_coded_flag ) { | |
| cu_{—}refinement_{—}flag | ae(v) |
| if( CuPredMode[ chType ][ x0 ][ y0 ] = = MODE_INTER && | |
| sps_sbt_enabled_flag && | |
| !ciip_flag[ x0 ][ y0 ] && cbWidth <= MaxTbSizeY && | |
| cbHeight <= MaxTbSizeY ) { | |
| allowSbtVerH = cbWidth >= 8 | |
| allowSbtVerQ = cbWidth >= 16 | |
| allowSbtHorH = cbHeight >= 8 | |
| allowSbtHorQ = cbHeight >= 16 | |
| if( allowSbtVerH \| \| allowSbtHorH ) | |
| cu_sbt_flag | ae(v) |
| if( cu_sbt_flag ) { | |
| if( ( allowSbtVerH \| \| allowSbtHorH ) && | |
| ( allowSbtVerQ \| \| allowSbtHorQ ) ) | |
| cu_sbt_quad_flag | ae(v) |
| if( ( cu_sbt_quad_flag && allowSbtVerQ && allowSbtHorQ ) \| \| | |
| ( !cu_sbt_quad_flag && allowSbtVerH && allowSbtHorH ) ) | |
| cu_sbt_horizontal_flag | ae(v) |
| cu_sbt_pos_flag | ae(v) |
| } | |
| } | |
| if( sps_act_enabled_flag && CuPredMode[ chType ][ x0 ][ y0 ] != | |
| MODE_INTRA && TreeType = = SINGLE_TREE ) | |
| cu_act_enabled_flag | ae(v) |
| LfnstDcOnly = 1 | |
| LfnstZeroOutSigCoeffFlag = 1 | |
| MtsDcOnly = 1 | |
| MtsZeroOutSigCoeffFlag = 1 | |
| transform_tree( x0, y0, cbWidth, cbHeight, treeType, chType ) | |
| if( cu_{—}refinenement_{—}flag ) | |
| refinement_{—}transform_{—}tree( x0, y0, cbWidth, cbHeight, treeType, chType ) | |
| ... | |

An example of the refinement_transform_tree( ) function is provided in Table 7 below. The refinement_transform_tree( ) function calls a function, named refinement_transform_unit( ) that performs the signaling of the refinement coefficients (the refinement-layer's coefficients), in a similar manner as done by the function transform_unit( ) of the VVC specification.

TABLE 7
A refinement transform tree function.

```
refinement_transform_tree( x0, y0, tbWidth, tbHeight , treeType, chType ) {
  InferTuCbfLuma = 1
  if( tbWidth > MaxTbSizeY | | tbHeight > MaxTbSizeY ) {
    verSplitFirst = ( tbWidth > MaxTbSizeY && tbWidth > tbHeight ) ? 1 : 0
    trafoWidth = verSplitFirst ? ( tbWidth / 2 ) : tbWidth
    trafoHeight = !verSplitFirst ? (tbHeight / 2 ) : tbHeight
    refinement_transform_tree( x0, y0, trafoWidth, trafoHeight, treeType, chType )
    if( verSplitFirst )
  refinement_transform_tree( x0 + trafoWidth, y0, trafoWidth, trafoHeight, treeType, chType )
    else
  refinement_transform_tree( x0, y0 + trafoHeight, trafoWidth, trafoHeight, treeType, chType )
  } else {
    refinement_transform_unit( x0, y0, tbWidth, tbHeight, treeType, 0, chType )
  }
}
```

Different sets of transform kernels can be used to transform a transform block, as described above. In an aspect, different sets of transform kernels may be used when an ESBT mode (or a combined ESBT-SBT mode) is applied and when an SBT mode is applied. Examples of sets of transform kernels used in these modes are provided in Table 8. Each line in the table corresponds to a possible example of transform sets. Other transform kernels (e.g., DCT-4 or DST-4) and sets with other combinations of transform kernels may be used.

TABLE 8
Transform sets for SBT and ESBT modes.

| Transform sets for SBT mode | Transform sets for ESBT mode |
|---|---|
| DST-7, DCT-8 | DCT-2, DST-7, DCT-8 |
| DST-7, DCT-8 | DCT-2 |
| DST-7, DCT-8 | DST-7, DCT-8 |
| DCT-2, DST-7, DCT-8 | DCT-2, DST-7, DCT-8 |
| DCT-2 | DCT-2, DST-7, DCT-8 |
| DCT-2 | DCT-2 |

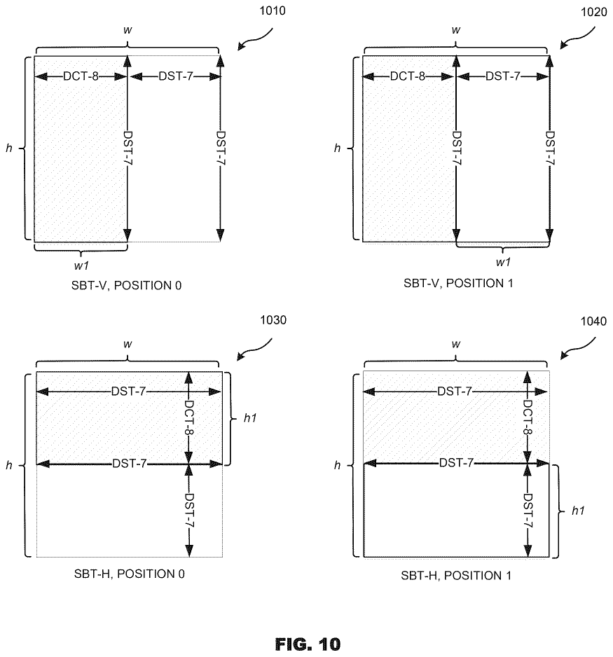

In an aspect, the transform kernels selected for subblock-1 (containing the down-sampled residual samples) may be derived from the transform used for the respective full resolution residual block. This can be achieved by using a complementary transform across the split boundary, as explained further in reference to FIG. 10. A complementary transform of a given transform is a transform whose base functions are in a reverse order to those of the given transform. For example, DCT8 is the complementary transform of DST7, and vice-versa. Similarly, DST4 is the complementary transform of DCT4, and vise-versa.

FIG. 10 illustrates selection of transform kernels. As illustrated, in an aspect, transform kernels, DCT8 and DST7, may be predefined for the full resolution transform block 1010, 1020, 1030, and 1040. These predefined kernels may be applied to the subblocks on the left and on the top of the transform block (patterned subblocks), as illustrated in FIG. 10. The selected transform kernels for the other (un-patterned) subblocks, are the respective complementary transforms across the split boundary (e.g., DCT8 is replaced by DST7, and vice versa), while the other direction uses the same transform kernels (DST7). For example, as illustrated in FIG. 10, for the case 1010 of “SBT-V, position 0”, horizontal transform DCT8 applies to the subblock on the left and complementary transform DST7 applies to the subblock on the right.

Different sets of transform kernels can be used by a base-layer (e.g., when employing the e-transformer 710 and inverse e-transformer 730, 830 of FIG. 7 and FIG. 8) and by the refinement-layer (e.g., when employing the transformer 740 and inverse transformer 755, 850 of FIG. 7 and FIG. 8). Examples of transform sets that can be used in these coding layers are provided in Table 9. Each line in the table corresponds to a possible example of transform sets. Other transform kernels (e.g., DCT-4 or DST-4) and sets with other combinations of transform kernels may be used.

TABLE 9
Transform sets for a base-layer and a refinement-layer.

| Transform sets for a base-layer | Transform sets for a refinement-layer |
|---|---|
| DCT-2, DST-7, DCT-8 | DCT-2, DST-7, DCT-8 |
| DCT-2, DST-7, DCT-8 | DST-7, DCT-8 |
| DCT-2, DST-7, DCT-8 | DST-2 |
| DCT-2, DST-7, DCT-8 | Walsh-Hadamard |

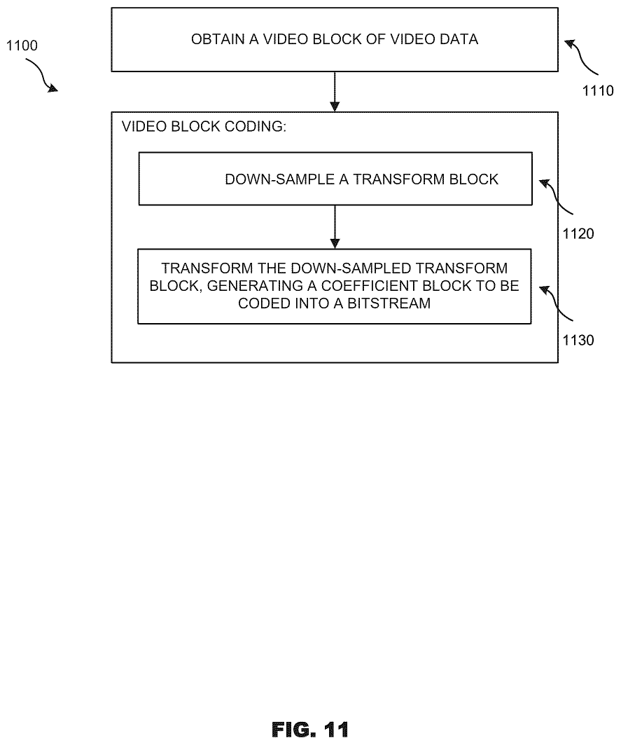

FIG. 11 is a flowchart of an example method for encoding video data 1100, focusing on the coding of transform blocks according to aspects described herein. The method 1100 may begin, in step 1110, by obtaining a video block of the video data to be encoded. According to aspects disclosed herein, the coding of the video block, in an ESBT mode, comprises steps 1120 and 1130. In step 1120, a transform block is down-sampled. The transform block contains residual samples, each representing a difference between corresponding samples of the video block and a prediction block, predicting the video block. Then, in step 1130, the down-sampled transform block is transformed (using transform kernels), generating a coefficient block to be coded into a bitstream.

In an aspect, a combined ESBT-SBT mode is applied, as described in reference to block 630 of FIG. 6. Accordingly, prior to the transforming of step 1130, a portion of the down-sampled transform block is set to zero, and the transformation 1130 is applied to the remaining portion of the down-sampled transform block to generate the coefficient block. In another aspect, the down-sampling of step 1120 and the transforming of step 1130 can be implemented by a wavelet transform, as described in reference to FIG. 9. Accordingly, a wavelet transform can be used to transform the transform block, generating wavelet coefficients, where the coefficient block of step 1130 comprises the low-band coefficients of the wavelet coefficients. In yet another aspect, the coding of the video block is refined, as described in reference to FIGS. 7 and 8. In this case, the coefficient block (that was coded into the bitstream in step 1130) is inverse transformed to reconstruct the down-sampled transform block, and the reconstructed down-sampled transform block is up-sampled to reconstruct the transform block. Then, a refinement block is generated, where each sample of the refinement block represents a difference between corresponding samples of the transform block and the reconstructed transform block. The refinement block is transformed, generating a refinement coefficient block that is also coded into the bitstream.

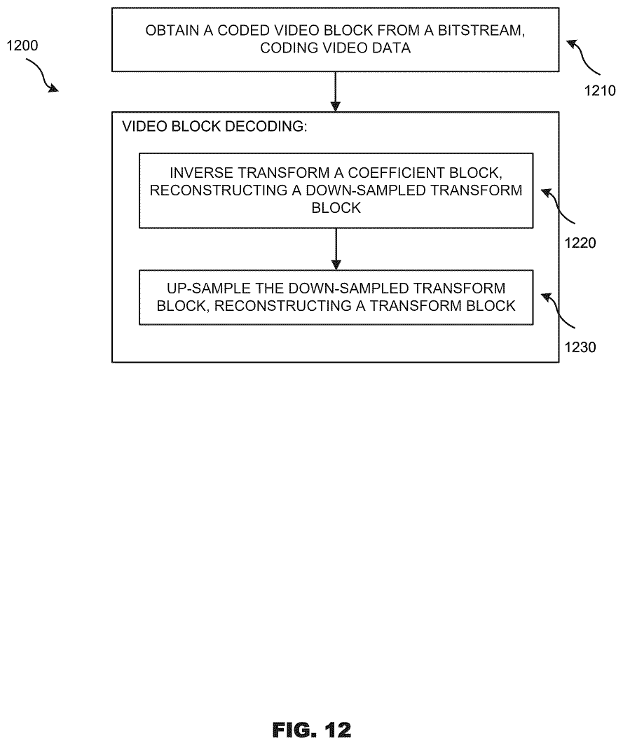

FIG. 12 is a flowchart of an example method for decoding video data 1200, focusing on the decoding of transform blocks according to aspects described herein. The method 1200 may begin, in step 1210, by obtaining, from a bitstream that codes the video data, a coded video block to be decoded. According to aspects disclosed herein, the decoding of the coded video block comprises steps 1220 and 1230—employed to reconstruct a transform block from a respective coefficient block. Where, the transform block contains residual samples, each representing a difference between corresponding samples of the video block and a prediction block that predicts the video block. Hence, in step 1220, the coefficient block is inverse transformed to reconstruct a down-sampled transform block. Then, in step 1230, the reconstructed down-sampled transform block is up-sampled, resulting in the reconstructed transform block. As disclosed herein, a transform block decoding 1200 may be performed according to coding parameters signaled in the bitstream, as described in reference to Tables 2-9.

Generally, it may be beneficial to adaptively modify the resolution of prediction blocks (and, thereby, the resolution of respective residual blocks) to obtain compression gains. This may be more relevant for low bitrates coding, where, when coding the video signal at full resolution, the compression impact may be high and may result in significant loss of details as well as coding artefacts such as blocking artefacts. The blocking artefacts can be significantly reduced when coding the video signal at lower resolution, while the loss of details, in general, is not higher than when coding at full resolution. The change of resolution can be applied at picture level. However, enabling a change of resolution at block level gives the encoder more flexibility—the encoder can choose locally (e.g., based on a rate-distortion criterion) whether to perform the encoding of a certain block at full resolution or at lower resolution. This flexibility results in coding gain, especially when encoding at low bitrates. Hence, further aspects of video encoding associated with an ESBT mode of operation are described next.

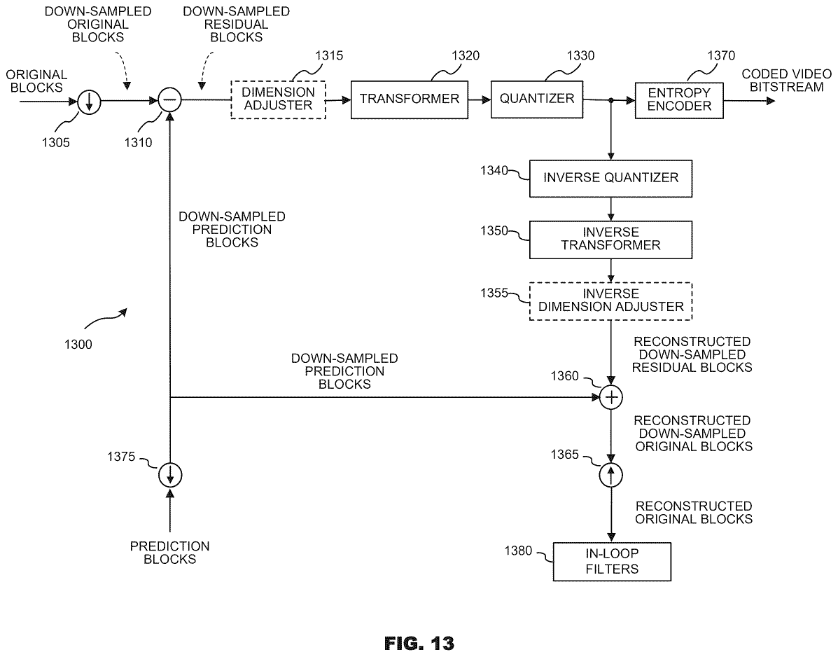

According to further aspects the original video blocks of a video frame and their respective prediction blocks are down-sampled before generating therefrom the residual blocks. Then an ESBT mode or a combined ESBT-SBT mode may be applied to the coding these residual blocks. This approach can be applied to video blocks for which any prediction mode is used (e.g., an intra-prediction mode, an inter-prediction mode, or a combined intra-inter-prediction mode). These further aspects are described below in reference to FIGS. 13-17.

FIG. 13 is a functional block diagram illustrating an enhanced video encoder 1300. The encoder 1300 of FIG. 13 is an augmented version of the encoder 200 of FIG. 2. Relative to encoder 200, encoder 1300 additionally uses down-samplers 1305, 1375, an up-sampler 1365, and, potentially, a dimension adjuster 1315 and an inverse dimension adjuster 1355. Note that not all the components shown in FIG. 2 appear in FIG. 13 (for clarity of presentation, components 202, 205, 260, 270, 275, 280, and 285 of FIG. 2 are not presented in FIG. 13).

As shown in FIG. 13, an original block and its respective prediction block are down-sampled by corresponding down-samplers 1305 and 1375. A down-sampled residual block—the difference between the down-sampled original block and the respective down-sampled prediction block—is next outputted by a subtractor 1310. The down-sampled residual block is processed by a transformer 1320, a quantizer 1330, an entropy encoder 1370, an inverse quantizer 1340, and an inverse transformer 1350 that respectively and similarly operate as the transformer 220, the quantizer 230, the entropy encoder 245, the inverse quantizer 240, and the inverse transformer 250 of FIG. 2. Accordingly, the down-sampled residual block is transformed, by the transformer 1320, and the resulted down-sampled coefficient block is quantized by the quantizer 1330. The generated quantized down-sampled coefficient block is entropy encoded by the entropy encoder 1370 (as well as respective coding parameters) and packed into the bitstream of the coded video. In addition, the quantized down-sampled coefficient block is dequantized by the inverse quantizer 1340 and then inverse transformed by the inverse transformer 1350, resulting in a reconstructed down-sampled residual block. To reconstruct the original block, the respective down-sampled prediction block is added 1360 to the reconstructed down-sampled residual block and the resulting reconstructed down-sampled original block is then upsampled 1365. In-loop filters 1380 can then be applied to the reconstructed picture (formed by the reconstructed original blocks), performing, for example, deblocking filtering and/or SAO filtering to reduce encoding artifacts.

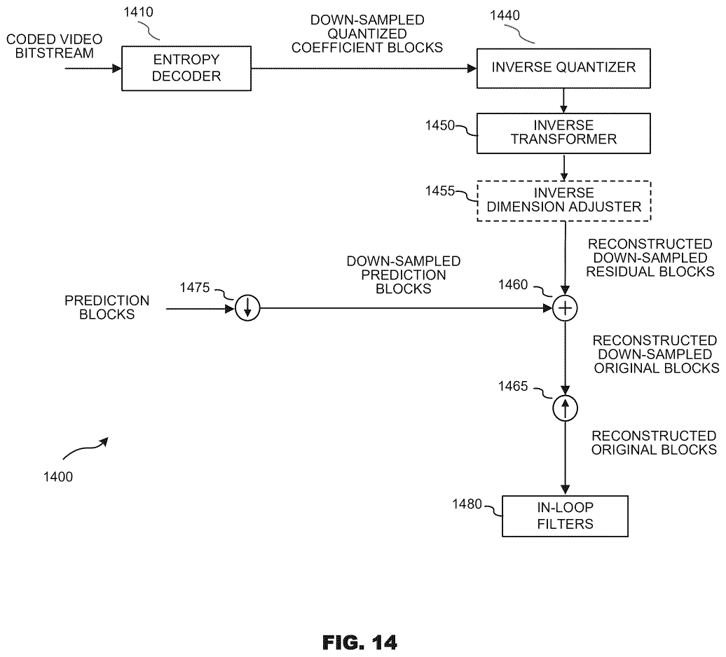

FIG. 14 is a functional block diagram illustrating an enhanced video decoder 1400. The decoder 1400 of FIG. 14 is an augmented version of the decoder 300 of FIG. 3. Relative to decoder 300, decoder 1400 additionally uses a down-sampler 1475, an up-sampler 1465, and, potentially, an inverse dimension adjuster 1455. Note that not all the components shown in FIG. 3 appear in FIG. 14 (for clarity of presentation, components 360, 370, 375, 380, and 390 are not presented in FIG. 14).

The decoder 1400 generally reverses the operation of the encoder 1300. Thus, the decoder 1400 first entropy decodes, by an entropy decoder 1410, from the bitstream of the coded video a down-sampled quantized coefficient block. The down-sampled quantized coefficient block is then dequantized by an inverse quantizer 1440, reversing the operation of the quantizer 1330 of FIG. 13 to provide a down-sampled coefficient block. The inverse transformer 1450 next reverses the operation of the transformer 1320 of FIG. 13, transforming the down-sampled coefficient block into a reconstructed down-sampled residual block. To reconstruct the original block, the respective down-sampled prediction block is added 1460 to the reconstructed down-sampled residual block and the resulted reconstructed down-sampled original block is then upsampled 1465. In-loop filters 1480 can then be applied to the reconstructed picture (formed by the reconstructed original blocks), duplicating the operation of the in-loop filters 1380 of the encoder 1300. The operations 1320, 1330, 1340, 1350, 1440, 1450 described above with respect to a residual block may be performed with respect to a partition of the residual block, that is, a transform block.

In an aspect, up-sampling 1365, 1465 of the reconstructed down-sampled original blocks may be applied after the application of the respective in-loop filters 1380, 1480 of the encoder 1300 and the decoder 1400. For example, deblocking filtering and/or SAO filtering may be applied 1380 in the encoder 1300 to a down-sampled picture (formed by the reconstructed down-sampled original blocks) and then the filtered down-sampled picture may be upsampled 1365, producing the filtered reconstructed picture to be stored in the reference picture buffer 280, shown in FIG. 2. Similarly, deblocking filtering and/or SAO filtering may be applied 1480 in the decoder 1400 to a down-sampled picture (formed by the reconstructed down-sampled original blocks) and then the filtered down-sampled picture may be upsampled 1465, producing the filtered reconstructed picture to be stored in the reference picture buffer 380, shown in FIG. 3.

The down-sampling 1305, 1375, 1475 and the up-sampling 1365, 1465 ratios may be different for the horizontal and the vertical directions and may be applied in one or both directions. The directions in which the down-sampling and up-sampling are applied, and the respective ratios may be inferred by the SBT-type, SBT-position, and splitting ratio information defined for the SBT mode. For example, signaling an SBT-type of SBT-V, an SBT-position 0, and a splitting ratio H (as illustrated by 410 of FIG. 4) may be the equivalent of down-sampling and up-sampling operations that are with a factor of 2 and that are applied in the horizontal direction, so that the down-sampled residual samples occupy the left half of the residual block (shaded area of 410). If, for example, the splitting ratio is Q, the down-sampling and the up-sampling operations are with a factor of 4, so that the down-sampled residual samples occupy the left quarter of the residual block. The filters used for the down-sampling and up-sampling operations may differ depending on the coding parameters—for example, the quantization parameters (QP) used to code the residual block or the transform block, the used prediction mode (intra-prediction mode or inter-inter prediction mode), the block vertical and/or horizontal sizes, and/or the transform type (kernel) applied to the residual samples. The filters used for the down-sampling and the up-sampling operations may also differ based on the coding context—for example, the type of the color component and/or an analysis of neighboring samples (e.g., their variance or gradient amplitudes).

In an aspect, the motion compensation operation (performed by the motion compensator 270, 375 to obtain a prediction block from a reference block) and the down-sampling operation (performed by the down-sampler 1375, 1475 to down-sample the obtained prediction block) can be combined into a temporal interpolation operation that can be expressed by the following pseudo-code:
temp_interpol(ref_block)=downsampling(motionComp(ref_block)),
where motionComp(.) denotes the motion compensation operation applied to the reference block ref_block, downsampling(.) denotes the down-sampling operation of the prediction block, and temp_interpol(.) denotes the temporal interpolation operation (a concatenation of the motion compensation and the down-sampling operations) applied to the reference block ref_block.

It may happen that the reference picture used to compute a prediction block is not at the same resolution as the original picture. This situation can occur when encoding according to the VVC standard for instance. In the VVC standard, a tool named Reference Picture Resampling (RPR) can be applied to perform the motion compensation operation on samples of the reference picture together with a resampling operation, so that the prediction block has the same resolution as the current block to be coded. In an aspect, the operation performed by the down-sampler 1375, 1475 represents a resampling operation, performed to obtain a resampled prediction block of the same resolution as the down-sampled original block and of the down-sampled residual block shown in FIG. 13, and of the reconstructed down-sampled residual block shown in FIG. 14. In a further aspect, the motion compensation operation can be concatenated with the resampling operation (into one temporal interpolation operation applied to a reference block) to obtain a resampled prediction block of the same resolution as the down-sampled original block and of the down-sampled residual block shown in FIG. 13, and of the reconstructed down-sampled residual block shown in FIG. 14. For instance, if a reference picture's resolution ratio is ½ in both dimensions compared to the original picture, and if the down-sampled original block (after 1305) has resolution ratio of 3/4 in both dimensions, the temporal interpolation operation must resample the reference block by a ratio (3/4)/(1/2)≈3/2 (effectively up-sampling the reference block). In another example, if a reference picture's resolution ratio is ½ in both dimensions compared to the original picture, and if the down-sampled original block (after 1305) has resolution ratio of ½ in both dimensions, the temporal interpolation operation must resample the reference block by a ratio (1/2)/(1/2)=1 (thus no resampling is required in this case).

In an aspect, the dimension of the down-sampled residual blocks may be adjusted by a dimension adjuster 1315, and, accordingly, inverse adjusted by an inverse dimension adjuster 1355, 1455, illustrated in the encoder 1300 of FIG. 13 and the decoder 1400 of FIG. 14. Adjusting the dimensions of the down-sampled residual block may be required in order to comply with the dimensions of a transform kernel used in transforming 1320 a transform block. For example, a down-sampled residual block may constitute a transform block or may be partitioned into multiple transform blocks, each of which must have a width and a height that are of a power of 2. To that end, the dimension adjuster 1315 may be employed to map (resample) the current dimension of the down-sampled residual block into a dimension that will result in transform blocks with widths and heights that are of a power of 2. Such an adjustment is reversed in the encoder 1300 and decoder 1400, respectively, by the inverse dimension adjusters 1355 and 1455. The dimension adjustment can be obtained by a resampling step, by a zeroing step, or by a combination of both.

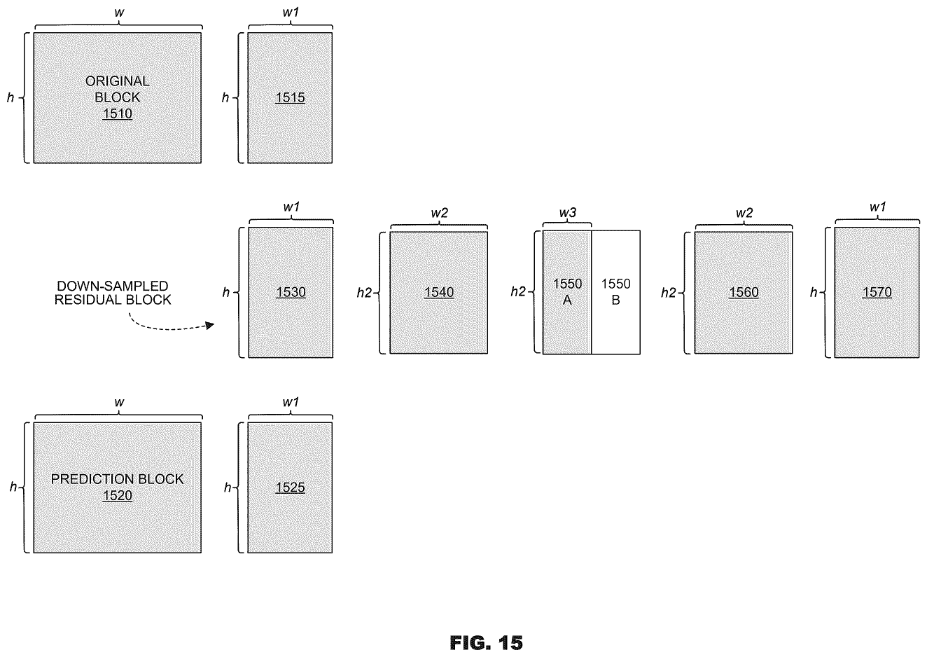

In an aspect, the encoder 1300 and the decoder 1400 may operate in both an ESBT mode and an SBT mode, as illustrated in FIG. 15. In the example of FIG. 15, an original block 1510 and a respective prediction block 1520, of width w and height h, are down-sampled (by respective down-samplers 1305 and 1375) in the horizontal direction using, for example, a sampling ratio of 1/2. The resulting down-sampled original block 1515 and down-sampled prediction block 1525 are of width w₁ and height h. Following subtraction 1310, a down-sampled residual block 1530 of width w₁ and height h is obtained. In a case where dimension adjustment is applied (employing the dimension adjuster 1315), the down-sampled residual block 1530 may be resampled, resulting in a resampled residual block 1540 of width w₂ and height h₂. Next, if an SBT mode is activated, a portion of the resampled residual block 1540 may be set to zero 1550B and only the remaining portion 1550A of width w₃ and height h₂ is being processed. That is, in an SBT mode, as described above, the residual samples that occupy block 1550A are transformed 1320, quantized 1330, entropy coded 1370, inverse quantized 1340, and inverse transformed 1350. The processed portion 1550A is then extended by zero values (corresponding to portion 1550B), resulting in a reconstructed residual block 1560 of width w₂ and height h₂. The dimension of the reconstructed residual block 1560 is next readjusted (by the inverse dimension adjuster 1355), generating a reconstructed residual block 1570 with dimensions that match the down-sampled residual block 1530. Note that the transformed 1320 and quantized 1330 residual samples that occupy block 1550A (i.e., respective quantized transform coefficients) are entropy-encoded into the bitstream, and, thus, in the decoder 1400, following the entropy-decoding 1410, the inverse quantizing 1440, and the inverse transforming 1450 operations, the dimensions of the resulting reconstructed residual block 1560 have to be readjusted 1455 (as in the encoder 1300) to obtain a reconstructed residual block 1570 with dimensions that match the down-sampled residual block 1530.

In an aspect, the operation of resampling, by the dimension adjuster 1315, of the down-sampled residual block 1530 into resampled residual block 1540 and the operation of setting to zero of a portion of that block 1540 (i.e., 1550B) in an SBT mode may be switched. In this case, a portion of the down-sampled residual block 1530 is first set to zero, and then the remaining portion is resampled by the dimension adjuster 1315. Similarly, in the decoder 1400, the reconstructed residual samples may be first resampled, by the inverse dimension adjuster 1455, and then extended by zero samples.

In the example of FIG. 15, the down-sampling 1305, 1375 is illustrated in the horizontal direction, reducing the number of samples by two (i.e., a sampling ratio of 1/2). The same process can be applied using different sampling ratios in the vertical direction or in both the vertical and the horizontal directions. In an aspect, a set of possible sampling ratios can be predefined by default and/or can be signaled in the bitstream. Different sets of sampling ratios may be used for luma and chroma residual samples. Furthermore, the set of possible sampling ratios may be based on the QP used by the quantizer 1330 to quantize the coefficient blocks (and by the inverse quantizer 1340, 1440 to dequantize the quantized coefficient blocks). For example, for low QP levels (corresponding to high bitrates), such as QP levels below 32, a sampling ratio of ½ may be considered. While, for high QP levels (corresponding to low bitrates), such as QP levels equal or above 32, sampling ratios 1/2 or 1/4 may be considered. In another aspect, the sampling ratio may be based on parameters such as SBT-type and SBT-position, defined for an SBT mode; the sampling ratio may be inferred from the signaled SBT-type and SBT-position. For example, SBT-type of SBT-V and SBT-position of 0 value can be used to infer sampling in the horizontal direction with a sampling ratio of 1/4, where the down-sampled transform block resides in the left quarter of the transform block.

The filters used as part of the down-sampling 1305, 1375, 1475 and the up-sampling 1365, 1465 processes may vary depending on the coding context and the coding parameters of the original block being coded. For example, these filters may be determined based on one or more factors such as: the QP used to quantize and dequantize the coefficient blocks, the prediction mode (intra or inter) used to predict the respective original block, the color component type, the image pattern in the original block's neighborhood (e.g., the level of image variance, the amplitude of image gradients), the transform block vertical and/or horizontal dimensions, or the transform kernel applied to the residual samples of the transform block.

In an aspect, the encoder 1300 may select, based on a result obtained from a testing process, whether to operate in an SBT mode, an ESBT mode, or a combined ESBT-SBT mode when coding a transform block. The testing process may afford the encoder 1300 the coding of more transform blocks in these modes. The testing process may employ various filters to filter corresponding samples from respective original blocks, prediction blocks, and/or residual blocks (before and/or after down-sampling) to determine, based on a coding cost measure, whether an SBT mode, an ESBT mode, or a combined ESBT-SBT mode should be used in the coding of a respective video block. The applied filters may be, for example, mean or gaussian filters (applied to remove high frequencies), median filters (effective at removing salt and paper noise), or bilateral filters (effective at noise removal while preserving the edges).

According to aspects, the use of an ESBT mode and its associated parameters can be signaled in the bitstream or can be inferred. In an aspect, syntax used to signal an SBT mode can be used to signal an ESBT mode for applications where an SBT mode is not utilized. As shown in Table 2, the coding of a transform block in an ESBT mode can be signaled using syntax element cu_sbt_flag. The direction of the down-sampling 1305, 1375, 1475 can be signaled using syntax element cu_sbt_horizontal_flag. And the sampling ratio of the down-sampling can be signaled using syntax element cu_sbt_quad_flag. Note that there is no need to indicate the position of subblock-1 that contains the down-sampled residual samples (that is, the subblock that the coefficient block is associated with); it can be inferred from the cu_sbt_horizontal_flag whether this subblock's position is on the left or on the top of the transform block. Therefore, in the example of Table 2, cu_sbt_pos_flag (used in the signaling syntax of Table 1) has been removed.

In the example of Table 3, the use of an ESBT mode is indicated by a new flag, cu_sbt_resampling_flag. As in the example of Table 2, when signaling the coding of a transform block in an ESBT mode, there is no need to signal the position (that is, cu_sbt_pos_flag is not signaled) since the position can be implicitly inferred as the left subblock or the top subblock, depending on the cu_sbt_horizontal_flag.

In the example of Table 4, modified syntax is illustrated that can be used to signal the coding of a transform block in a combined ESBT-SBT mode (as described in reference to FIG. 15). In Table 4, when cu_sbt_resampling_flag is true, syntax elements cu_sbt_resampling_horizontal_ratio and cu_sbt_resampling_vertical_ratio can be used to signal the horizontal and the vertical sampling ratios (shown in italics). In this case, the portion of the down-sampled transform block 1550 that is set to zero (to form block 1550A) can be signaled using syntax element cu_sbt_quad_flag.

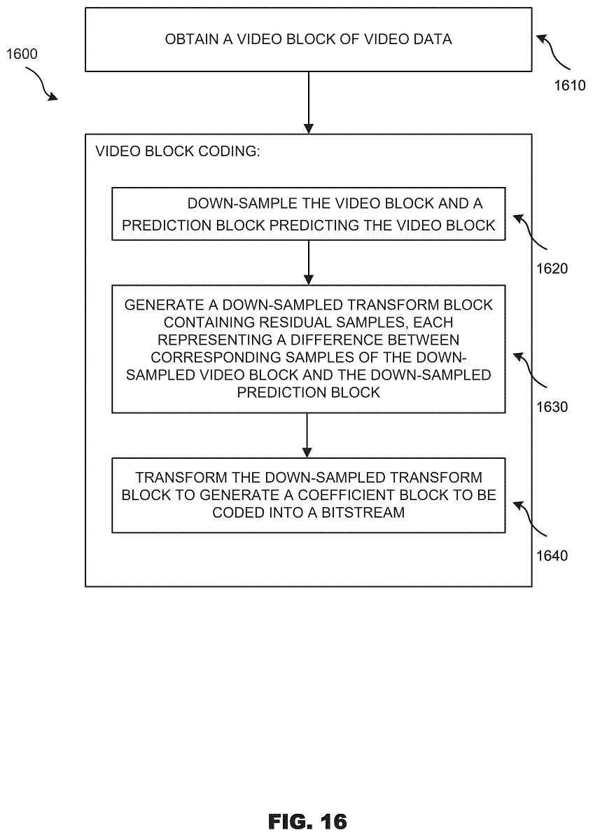

FIG. 16 is a flowchart of an example method for encoding video data 1600. The method 1600 may begin, in step 1610, by obtaining a video block (i.e., an original block) of the video data to be encoded. According to aspects disclosed herein, the coding of the video block comprises steps 1620 to 1640. In step 1620, the video block and a prediction block that predicts the video block are down-sampled 1305, 1375. Next, in step 1630, a down-sampled transform block (i.e., a down-sampled residual block or a partition thereof) is generated 1310. The generated down-sampled transform block contains residual samples, each representing a difference between corresponding samples of the down-sampled video block and the down-sampled prediction block. In step 1640, the down-sampled transform block is then transformed 1320 to generate a coefficient block to be coded into a bitstream of the coded video data. In an aspect, the method 1600 includes a step of adjusting 1315 at least one dimension of the down-sampled transform block to conform to a dimension of a transform kernel used in the transforming 1320 of the down-sampled transform block.

Method 1600 further comprises the operation of inverse transforming 1350 the coefficient block (generated in step 1640) to reconstruct a down-sampled transform block. A reconstructed down-sampled video block is then generated by adding 1360 the down-sampled transform block to the down-sampled prediction block. The reconstructed down-sampled video block is up-sampled 1365 to generate a reconstructed video block. In an aspect, a reconstructed picture (containing the reconstructed video blocks) is in-loop filtered 1380. In another aspect, a reconstructed down-sampled picture (containing the reconstructed down-sampled video blocks) is first in-loop filtered 1380, and the up-sampling 1365 is applied to the in-loop filtered reconstructed down-sampled picture. In another aspect, prior to the down-sampling of step 1620, the video block and the prediction block are filtered, using a filter whose parameters are determined based on a coding context and/or a coding parameter of the video block.

The coding of video blocks, as described herein, is associated with an ESBT mode of operation. Encoding in an ESTB mode of operation may be signaled in the bitstream using syntax element cu_sbt_flag, including the signaling of a direction of the down-sampling with syntax element cu_sbt_horizontal_flag and the signaling of a sampling ratio of the down-sampling with syntax element cu_sbt_quad_flag (see Table 2). The encoding in an ESTB mode may also be signaled using syntax element cu_sbt_resampling_flag (see Table 3). The coding of video blocks may be associated with a combined ESBT-SBT mode of operation. In this mode, a portion of the down-sampled transform block is set to zero and the remaining portion of the down-sampled transform block is then transformed to generate the coefficient block (as described in reference to FIG. 15). When operating in a combined ESBT-SBT mode, the encoder may signal in the bitstream the portion of the down-sampled transform block that is set to zero using syntax element cu_sbt_quad_flag, and the sampling ratio of the down-sampling using syntax elements cu_sbt_resampling_horizontal_ratio and cu_sbt_resampling_vertical_ratio (see Table 4).

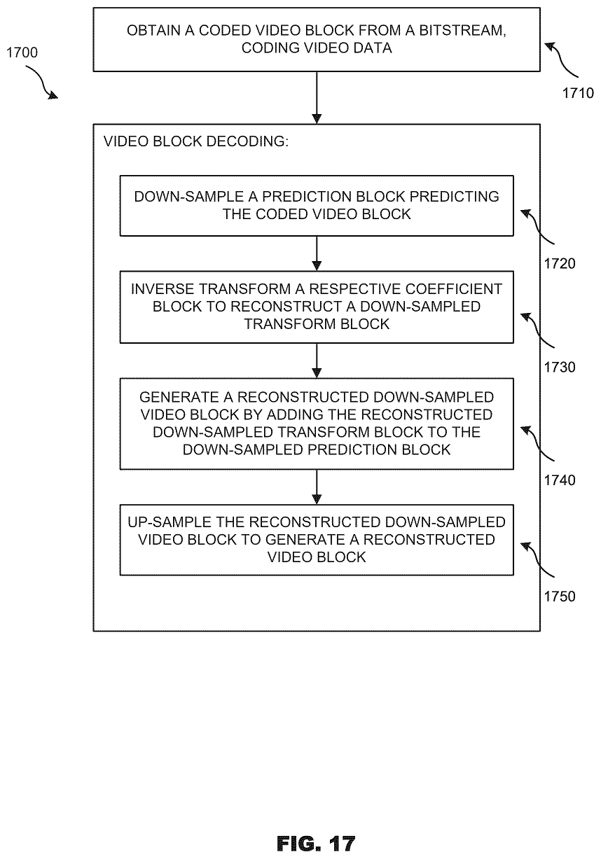

FIG. 17 is a flowchart of an example method for decoding video data 1700. The method 1700 may begin, in step 1710, by obtaining, from a bitstream that codes the video data, a coded video block to be decoded. According to aspects disclosed herein, the decoding of the coded video block comprises steps 1720 to 1750. In step 1720, a prediction block, predicting the coded video block, is down-sampled 1475. In step 1730, a respective coefficient block is inverse transformed 1450 to reconstruct a down-sampled transform block. The down-sampled transform block may be a partition of a down-sampled residual block. Next, in step 1740, a reconstructed down-sampled video block is generated by adding 1460 the reconstructed down-sampled transform block to the down-sampled prediction block. Then, in step 1750, the reconstructed down-sampled video block is up-sampled 1465 to generate a reconstructed video block. As disclosed herein, the decoding method 1700 may be performed according to coding parameters signaled in the bitstream, as described in reference to Tables 2-4.

We have described several aspects and embodiments in the present disclosure. These aspects and embodiments provide at least the following outputs and results, including all combinations, across different claim categories and types:
Encoding, into coded video data, syntax elements that can enable the decoder to decode the coded video data, according to any of the aspects described herein.
A bitstream that includes one or more of the described syntax elements, or variations thereof. A bitstream can be any set of data whether transmitted, stored, or otherwise made available.
Creating, transmitting, receiving, and/or decoding of the bitstream.
An electronic device (e.g., a TV, a set-top box, a cell phone, or a tablet) that tunes (e.g., using a tuner) a channel to receive the bitstream or that receives (e.g., using an antenna) the bitstream over the air. The electronic device decodes the syntax elements from the bitstream, and, optionally, displays (e.g., using a monitor, screen, or any other type of display) a resulting image.
   Various other generalized, as well as particularized, outputs, results, implementations, and claims are also supported and contemplated throughout this disclosure.

Various methods are described herein, and each of the methods comprises one or more steps or actions for achieving the described method. Unless a specific order of steps or actions is required for the proper operation of the method, the order and/or use of specific steps and/or actions can be modified or combined. Additionally, terms such as “first”, “second”, etc. can be used in various embodiments to modify an element, component, step, operation, etc., for example, a “first decoding” and a “second decoding”. Use of such terms does not imply an ordering to the modified operations unless specifically required. So, in this example, the first decoding need not be performed before the second decoding, and can occur, for example, before, during, or in an overlapping time period with the second decoding.

Various methods and other aspects described in this application can be used to modify modules, for example, the modules of the video encoder 200 and the video decoder 300 as shown in FIG. 2 and FIG. 3. Moreover, the present aspects are not limited to a specific standard (such as VVC or HEVC) and can be applied, for example, to other standards and recommendations, as well as extensions of any such standards and recommendations. Unless indicated otherwise, or technically precluded, the aspects described in this application can be used individually or in combination.

Various numeric values are used in the present application. The specific values are for example purposes and the aspects described are not limited to these specific values.

Various implementations involve decoding. “Decoding,” as used in this application, can encompass all or part of the processes performed, for example, on a received encoded sequence in order to produce a final output suitable for display. In various embodiments, such processes include one or more of the processes typically performed by a decoder, for example, entropy decoding, inverse quantization, inverse transformation, and differential decoding. Whether the phrase “decoding process” is intended to refer specifically to a subset of operations or generally to the broader decoding process will be clear based on the context of the specific descriptions and is believed to be well understood by those skilled in the art.

Various implementations involve encoding. In an analogous way to the above discussion about “decoding”, “encoding” as used in this application can encompass all or part of the processes performed, for example, on an input video data in order to produce an encoded bitstream. Additionally, the terms “reconstructed” and “decoded” can be used interchangeably, the terms “encoded” or “coded” can be used interchangeably, and the terms “image,” “picture,” and “frame” can be used interchangeably. Usually, but not necessarily, the term “reconstructed” is used on the encoder side while the term “decoded” is used on the decoder side.

Note that the syntax elements as used herein are descriptive terms. As such, they do not preclude the use of other syntax element names.

This disclosure has described various pieces of information, such as for example syntax, that can be transmitted or stored, for example. This information can be packaged or arranged in a variety of manners, including, for example, manners that are common in video standards such as putting the information into an SPS, a PPS, a NAL unit, a header (for example, a NAL unit header, or a slice header), or an SEI message. Other manners are also available, including, for example, manners common for system level or application level standards such as signaling the information into one or more of the following:
a. SDP (session description protocol), a format for describing multimedia communication sessions for the purposes of session announcement and session invitation, for example, as described in RFCs and used in conjunction with RTP (Real-time Transport Protocol) transmission.
b. DASH MPD (Media Presentation Description) Descriptors, for example, as used in DASH and transmitted over HTTP. A descriptor is associated with a Representation or collection of Representations to provide additional characteristics to the content Representation.
c. RTP header extensions, for example, as used during RTP streaming.
d. ISO Base Media File Format, for example, as used in OMAF and using boxes which are object-oriented building blocks defined by a unique type identifier and length (also known as ‘atoms’ in some specifications).
e. HLS (HTTP live Streaming) manifest transmitted over HTTP. A manifest can be associated, for example, with a version or collection of versions of content to provide the characteristics of the version or collection of versions.

The implementations and aspects described herein can be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus can be implemented in, for example, appropriate hardware, software, and firmware. The methods can be implemented in, for example, an apparatus, for example, a processor, which refers to processing devices in general, including, for example, a computer, a microprocessor, an integrated circuit, or a programmable logic device. Processors also include communication devices, for example, computers, cell phones, portable/personal digital assistants (PDAs), and other devices that facilitate communication of information between end-users.

Reference to “one/an aspect” or “one/an embodiment” or “one/an implementation,” as well as other variations thereof, means that a particular feature, structure, characteristic, and so forth described in connection with the aspect/embodiment/implementation is included in at least one embodiment. Thus, the appearances of the phrase “in one/an aspect” or “in one/an embodiment” or “in one/an implementation,” as well any other variations, appearing in various places throughout this application, are not necessarily all referring to the same embodiment.

Additionally, this application can refer to “determining” various pieces of information. Determining the information can include one or more of, for example, estimating the information, calculating the information, predicting the information, or retrieving the information from memory.

Further, this application may refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing,” intended to be a broad term. Receiving the information can include one or more of, for example, accessing the information, or retrieving the information (for example, from memory). Further, “receiving” is typically involved, in one way or another, during operations, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B,” is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This can be extended, as is clear to one of ordinary skill in this and related arts, for as many items as are listed.

Also, as used herein, the word “signal” refers to, among other things, indicating something to a corresponding decoder. For example, in certain embodiments the encoder signals a quantization parameter for de-quantization. In this way, in an embodiment the same parameter is used at both the encoder side and the decoder side. Thus, for example, an encoder can transmit (explicit signaling) a particular parameter to the decoder so that the decoder can use the same particular parameter. Conversely, if the decoder already has the particular parameter as well as others, then signaling can be used without transmitting (implicit signaling) to simply allow the decoder to know and select the particular parameter. By avoiding transmission of any actual data, a bit savings is realized in various embodiments. It is to be appreciated that signaling can be accomplished in a variety of ways. For example, one or more syntax elements, flags, and so forth are used to signal information to a corresponding decoder in various embodiments. While the preceding relates to the verb form of the word “signal”, the word “signal” can also be used herein as a noun.

As will be evident to one of ordinary skill in the art, implementations can produce a variety of signals formatted to carry information that can be, for example, stored or transmitted. The information can include, for example, instructions for performing a method, or data produced by one of the described implementations. For example, a signal can be formatted to carry the bitstream of a described embodiment. Such a signal can be formatted, for example, as an electromagnetic wave (for example, using a radio frequency portion of spectrum) or as a baseband signal. The formatting can include, for example, encoding a data stream and modulating a carrier with the encoded data stream. The information that the signal carries can be, for example, analog or digital information. The signal can be transmitted over a variety of different wired or wireless links, as is known. The signal can be stored on a processor-readable medium.

1. A method for encoding video data, comprising:
coding, into a bitstream, a video block of the video data, the coding comprises:
down-sampling a transform block, and
transforming the down-sampled transform block, generating a coefficient block to be coded into the bitstream,
wherein the transform block contains residual samples, each representing a difference between corresponding samples of the video block and a prediction block that predicts the video block.

2. The method according to claim 1, wherein the down-sampling comprises:
down-sampling the video block and the prediction block; and
generating the down-sampled transform block by subtracting corresponding samples of the down-sampled video block and the down-sampled prediction block.

3. The method according to claim 1, wherein the coding of the video block is performed in an ESBT mode and is further comprising:
signaling in the bitstream the coding in the ESBT mode using a syntax element cu_sbt_flag.

4. The method according to claim 1, further comprising:
signaling in the bitstream a direction of the down sampling using a syntax element cu_sbt_horizontal_flag.

5. The method according to claim 1, further comprising:
signaling in the bitstream a sampling ratio of the down sampling using a syntax element cu_sbt_quad_flag.

6. The method according to claim 1, further comprising:
further signaling in the bitstream the coding in the ESBT mode using a syntax element cu_sbt_resampling_flag.

7. The method according to claim 1, further comprising:
prior to the transforming, setting a portion of the down-sampled transform block to zero, wherein the transforming comprises transforming the remaining portion of the down-sampled transform block to generate the coefficient block.

8. The method according to claim 1, wherein the coding of the video block is performed in a combined ESBT-SBT mode and further comprising:
signaling in the bitstream:
the portion of the down-sampled transform block set to zero using a syntax element cu_sbt_quad_flag, and
a sampling ratio of the down sampling using syntax elements cu_sbt_resampling_horizontal_ratio and cu_sbt_resampling_vertical_ratio.

9. The method according claim 1, further comprising:
inverse transforming the coefficient block, reconstructing the down-sampled transform block,
up-sampling the reconstructed down-sampled transform block, reconstructing the transform block,
generating a refinement block, each sample of the refinement block represents a difference between corresponding samples of the transform block and the reconstructed transform block, and
transforming the refinement block, generating a refinement coefficient block to be coded into the bitstream.

10. The method according to claim 1, further comprising:
signaling in the bitstream the coding of the refinement coefficient block using a syntax element cu_refinement_flag.

11. The method according to claim 1, further comprising:
prior to the down-sampling, filtering the transform block using a low-pass filter, a median filter, a bilateral filter, or a combination thereof.

12-13. (canceled)

14. A method for decoding video data, comprising:
decoding, from a bitstream, a video block of the video data, the decoding comprises:
inverse transforming a coefficient block, reconstructing a down-sampled transform block, and
up-sampling the down-sampled transform block, reconstructing a transform block,
wherein the transform block contains residual samples, each representing a difference between corresponding samples of the video block and a prediction block that predicts the video block.

15. The method according to claim 14, wherein the decoding of the video block is performed in an ESBT mode and is further comprising:
decoding from the bitstream a syntax element, cu_sbt_flag, indicating the coding in the ESBT mode.

16. The method according to claim 14, further comprising:
decoding from the bitstream a syntax element, cu_sbt_horizontal_flag, indicating a direction of the down sampling.

17. The method according to of claim 14, further comprising:
decoding from the bitstream a syntax element, cu_sbt_quad_flag, indicating a sampling ratio of the down sampling.

18. The method according to claim 14, further comprising:
further decoding from the bitstream using a syntax element, cu_sbt_resampling_flag, indicating the coding in the ESBT mode.

19. An apparatus for encoding video data, comprising:
at least one processor; and
memory storing instructions that, when executed by the at least one processor, cause the apparatus to:
code, into a bitstream, a video block of the video data, the coding comprises:
down-sampling a transform block, and
transforming the down-sampled transform block, generating a coefficient block to be coded into the bitstream,
wherein the transform block contains residual samples, each representing a difference between corresponding samples of the video block and a prediction block that predicts the video block.

20. The apparatus according to claim 19, wherein the down-sampling and the transforming comprises:
transforming, using a wavelet transform, the transform block, generating wavelet coefficients containing low-band coefficients, wherein the coefficient block comprises the low-band coefficients.

21. The apparatus according to claim 20, further comprising:
signaling in the bitstream:
a wavelet filter type using a syntax element cu_sbt_resampling_filter_type, and
a wavelet depth using syntax elements cu_sbt_resampling_horizontal_depth and cu_sbt_resampling_vertical_depth.

22. An apparatus for decoding video data, comprising:
at least one processor; and
memory storing instructions that, when executed by the at least one processor, cause the system to:
decode, from a bitstream, a video block of the video data, the decoding comprises:
inverse transforming a coefficient block, reconstructing a down-sampled transform block,
up-sampling the down-sampled transform block, reconstructing a transform block,
wherein the transform block contains residual samples, each representing a difference between corresponding samples of the video block and a prediction block that predicts the video block.
